(19) United States
(12) Patent Application Publication
(10) Pub. No.: US 2025/0273091 A1
(43) Pub. Date: Aug. 28, 2025

(54) REPRESENTATIONS OF HUMAN BODY PARTS WITH APPROPRIATELY-POSITIONED SENSORS AND MECHANICAL CHARACTERISTICS FOR TESTING AND VALIDATING WEARABLE DEVICES, AND SYSTEMS AND METHODS OF USE THEREOF

(71) Applicant: Meta Platforms Technologies, LLC, Menlo Park, CA (US)

(72) Inventors: Derek Sears, Lynnwood, WA (US); Thomas Jos Mannuthy, Pleasanton, CA (US)

(21) Appl. No.: 19/060,620

(22) Filed: Feb. 21, 2025

Related U.S. Application Data
(60) Provisional application No. 63/558,020, filed on Feb. 26, 2024.

(51) Int. Cl. G09B 23/30; G01N 29/34; G06F 3/01; G06F 30/20

(52) U.S. Cl. CPC G09B 23/30; G01N 29/34; G06F 30/20; G06F 3/011

(57) ABSTRACT

A physical representation of a human body part is described. The physical representation of the human body part includes a first physical representation of a first portion of the human body part, a second physical representation of a second portion of the human body part, and an amplifier. The first physical representation of the first portion of the human body part includes a first actuator and interfaces with a portion of a head-wearable device. The second physical representation of the second portion of the human body part includes a second actuator. The amplifier is coupled with the first and second actuators. The amplifier drives the first and second actuators based on an incoming signal, such that at respective physical representation of respective portions of the human body part are caused to imitate human reactions.

### CROSS-REFERENCE TO RELATED APPLICATIONS

This application claims priority to U.S. Prov. App. No. 63/558,020, filed on Feb. 26, 2024, and entitled “Wearable Devices Validated And Tested By Specially Designed Representations Of Human Body Parts With Appropriately-Positioned Sensors And Mechanical Characteristics, And Systems And Methods Of Use Thereof,” which is incorporated herein by reference.

### TECHNICAL FIELD

This relates generally to wearable devices for use in extended-reality systems (e.g., virtual reality systems and/or augmented reality systems), including but not limited to techniques for configuring sensors on a physical representation of a human body part (e.g., a mannequin) to provide data that can be used to determine the appropriate size and shape of ergonomic features of wearable devices.

### BACKGROUND

Users of extended-reality wearable devices can become substantially immersed in the extended-reality environment, which can be conducive to a richer, more engaging user experience. However, one drawback to existing extended-reality wearable devices is that users experience discomfort due to the heat emitted from the wearable devices, the excessive vibrations emitted from the wearable devices, and the weight of the wearable devices. Being uncomfortable while wearing the wearable devices can impair the users' immersion in the extended-reality environment and limit the amount of time users can spend in the extended-reality environment.

Techniques for making the extended-reality wearable devices more comfortable exist but are not accurate and can still lead to the issues noted above. Accordingly, there is a need for more accurate techniques.

As such, there is a need to address one or more of the above-identified challenges. A brief summary of solutions to the issues noted above are described below.

### SUMMARY

The devices described herein allow users wearing extended-reality wearable devices to engage with an extended-reality environment in an immersive and interactive manner by minimizing the discomfort experienced while wearing the wearable devices. Distributing a variety of sensors underneath and throughout the surface layer of a physical representation of a human body part allows for the collection of data that can be used to design ergonomic features of the wearable device. The sensors are located at positions on the physical representation of a human body part that correspond to locations on a user's body part where the user might experience physical sensations from the wearable device. The data collected determines the parameters that make the wearable device comfortable for users to wear.

One example of an extended-reality wearable device is described herein. This example of an extended-reality wearable device includes an ergonomic feature of the wearable device, where the ergonomic feature is sized and shaped partially based on data received from one or more sensors. The one or more sensors are located at predetermined positions within or on a physical representation of a human body part. The predetermined positions correspond to a wearability parameter affected by the ergonomic feature. The data received from the one or more sensors is used to determine a thermal-based wearability parameter indicating an amount heat transferred from the wearable device to the physical representation of the human body part, a mechanical-based wearability parameter indicating an amount of mechanical force transferred from one or more electro-mechanical components located within the wearable device to the physical representation of the human body part, and a pressure-based wearability parameter indicating an amount of pressure applied by the wearable device to the physical representation of a human body part while affixed.

Having summarized the first aspect generally related to wearable devices comprising ergonomic features designed, at least in part, using sensors within and/or on a physical representation of a human body part, the second aspect, physical representations of human body parts comprising sensors that provide data used to design ergonomic features of wearable devices is now summarized.

An example of a device used to provide data that can help determine the ergonomic features of a wearable device is described herein. This example of such a device includes a physical representation of a human body part used for measuring an ergonomic feature of a wearable device of an extended-reality system. The physical representation of a human body part includes one or more sensors coupled with the physical representation of the human body part, where the physical representation of a human body part is configured to interface with a wearable device. The one or more sensors are configured to provide data that is used to determine an ergonomic feature of the wearable device, where the data is used to determine a thermal-based wearability parameter indicating an amount of heat transferred from the wearable device to the physical representation of a human body part, a mechanical-based wearability parameter indicating an amount of mechanical force transferred from one or more electro-mechanical components located within the wearable device to the physical representation of a human body part, and a pressure-based wearability parameter indicating an amount of pressure applied by the wearable device to the physical representation of a human body part while affixed.

Another example of a device used for testing wearable devices, such as a head- wearable device, is described herein. The device used for testing wearable devices includes a physical representation of a human body part. The physical representation of a human body part includes a first physical representation of a first portion of the human body part including a first actuator, a second physical representation of a second portion of the human body part including a second actuator, and an amplifier coupled with the first actuator and the second actuator. The first physical representation of the first portion of the human body part interfaces with a portion of a head-wearable device. The amplifier, in response to receiving an incoming signal via an interface, drives at least one of the first actuator and the second actuator based on the incoming signal, such that at least one of the first physical representation of the first portion of the human body part and the second physical representation of the second portion of the human body part are caused to imitate a human reaction.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A illustrates a head-worn wearable device for use in an extended-reality system placed upon a physical representation of a human head that is configured to record data from one or more sensors, in accordance with some embodiments.

FIG. 1B illustrates an adjusted head-worn wearable device with an adjusted design placed upon the physical representation of a human head based on sensor data retrieved from one or more sensors of the physical representation of a human head, in accordance with some embodiments.

FIG. 2A illustrates an arm-worn wearable device for use in an extended-reality system placed upon a physical representation of a human arm that is configured to record data from one or more sensors, in accordance with some embodiments.

FIG. 2B illustrates an adjusted arm-worn wearable device with an adjusted design placed upon the physical representation of a human arm based on sensor data retrieved from one or more of the sensors of the physical representation of a human arm, in accordance with some embodiments.

FIG. 3 illustrates the swappable portions of the physical representations of a human head and the physical representation of a human arm, in accordance with some embodiments.

FIG. 4 illustrates a placement of mechanical force sensors in a region of the physical representation of a human head, in accordance with some embodiments.

FIG. 5 illustrates two example placements of pressure sensors in a region of the physical representation of a human head, in accordance with some embodiments.

FIG. 6 illustrates a placement of heat flux sensors on and fluid channels within the physical representation of a human head, in accordance with some embodiments.

FIG. 7 illustrates a placement of mechanical force sensors, pressure sensors, and/or heat flux sensors on the physical representation of a human arm, in accordance with some embodiments.

FIG. 8 illustrates another physical representation of a human body part, in accordance with some embodiments.

FIGS. 9A-9C illustrate different views of the other physical representation of the human body part, in accordance with some embodiments.

FIGS. 10A 10B, 10C-1, and 10C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The devices described herein include wearable devices for use in extended-reality systems (such as augmented reality systems and/or virtual reality systems) and physical representations of human body parts comprising sensors. The wearable devices include ergonomic features which make the wearable devices more comfortable for users and/or wearers of the wearable devices. The ergonomic features are designed based on data received from the sensors placed on the surface of the physical representation, embedded within the surface of the physical representation, or placed below the surface of the physical representation. The placement of the sensors is predetermined based on the parameters that the sensors are measuring. The sensors can measure data relating to the amount of heat transferred from the wearable device to the physical representation, the amount of mechanical force transferred from the wearable device to the physical representation, the amount of pressure applied by the wearable device to the physical representation, and other parameters that can reduce the discomfort experienced by users wearing the wearable devices.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

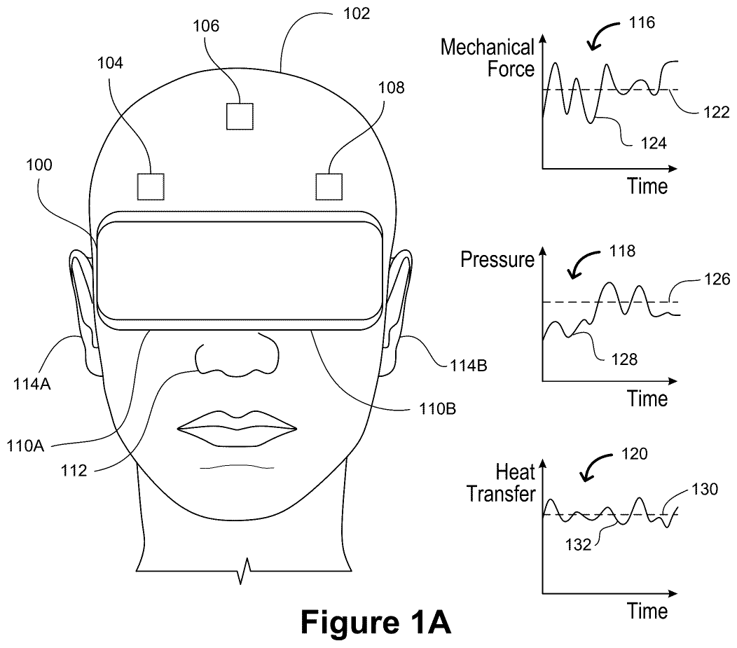

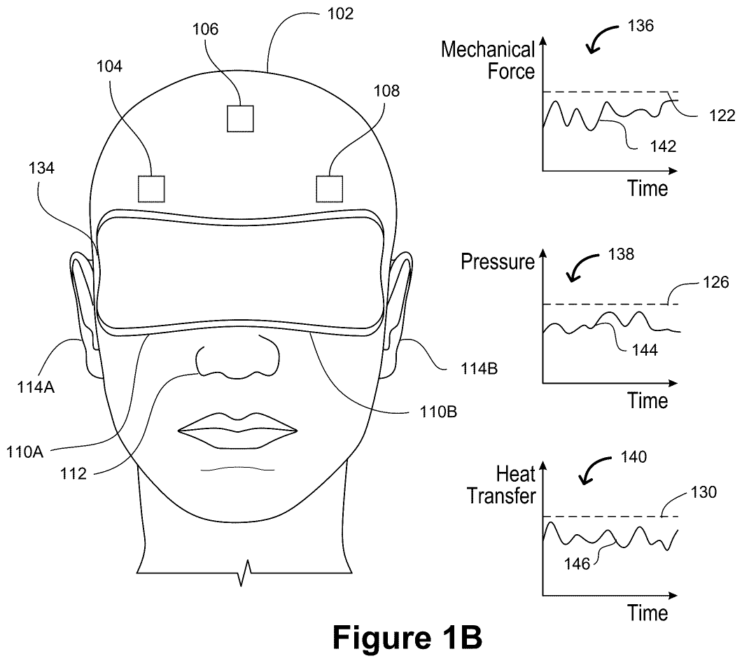

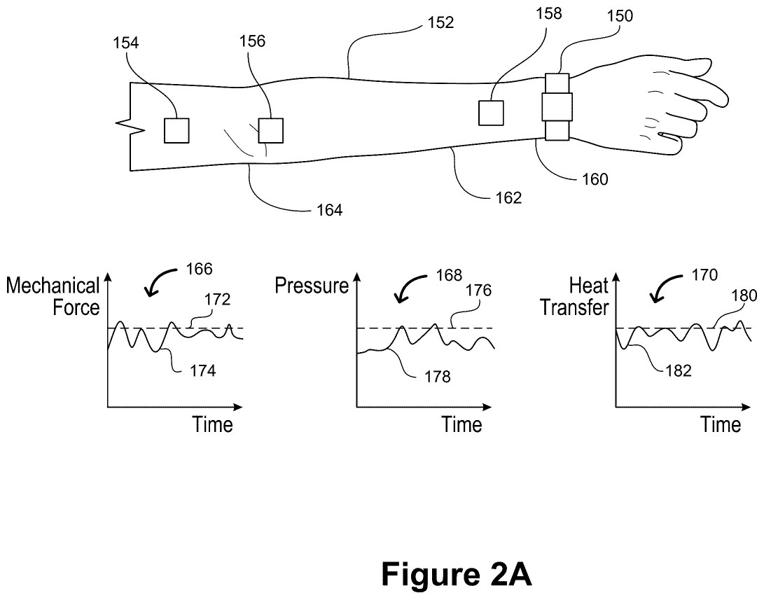

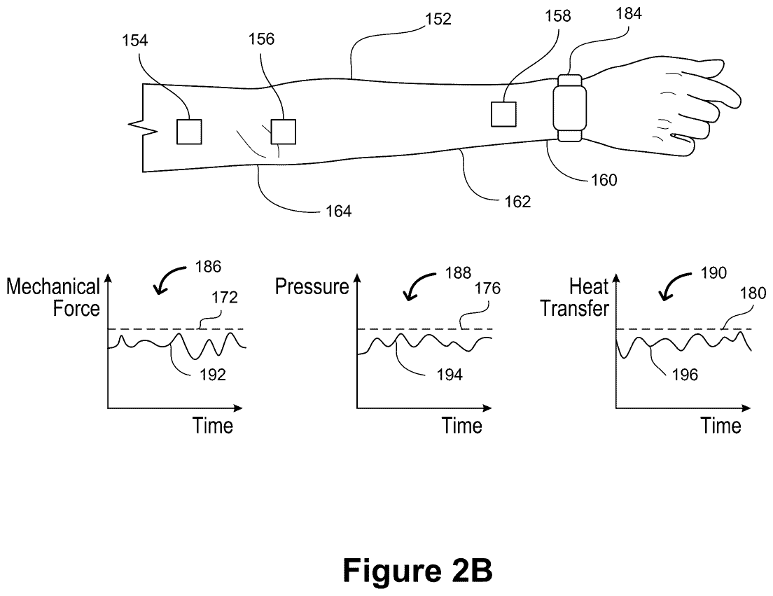

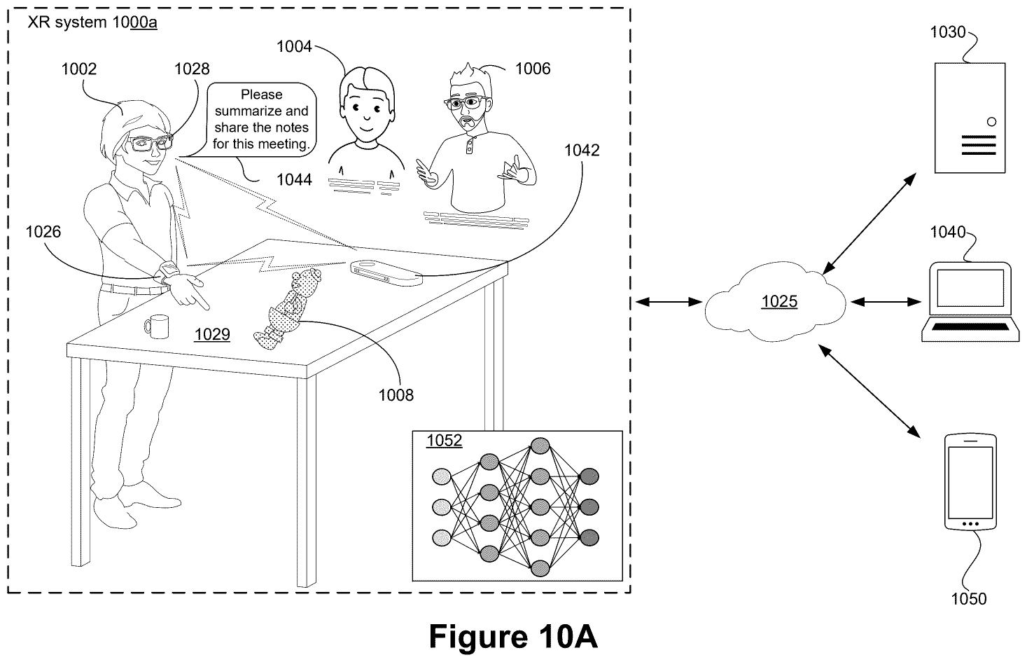

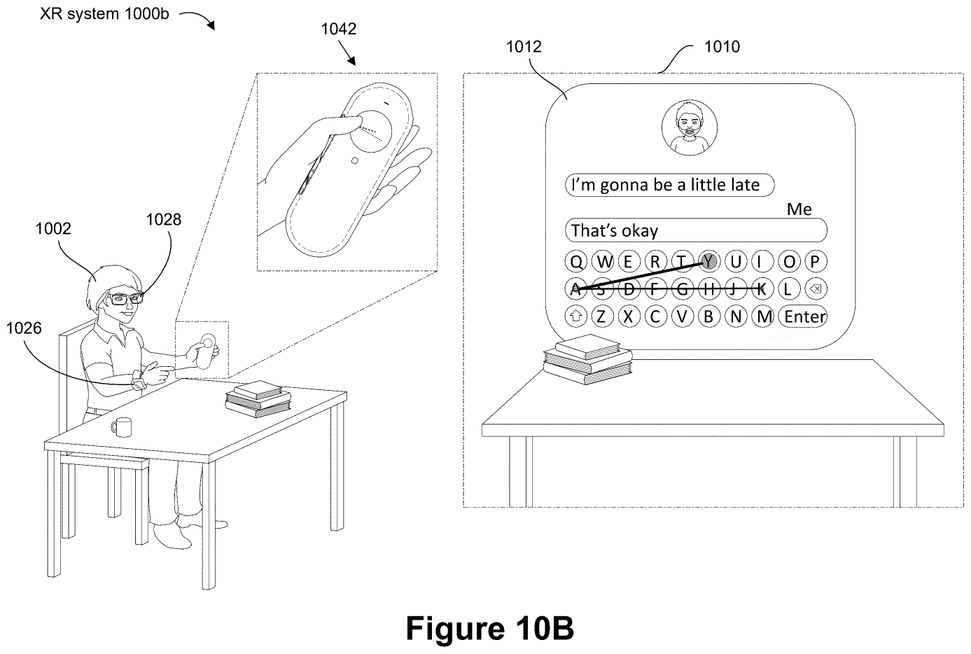

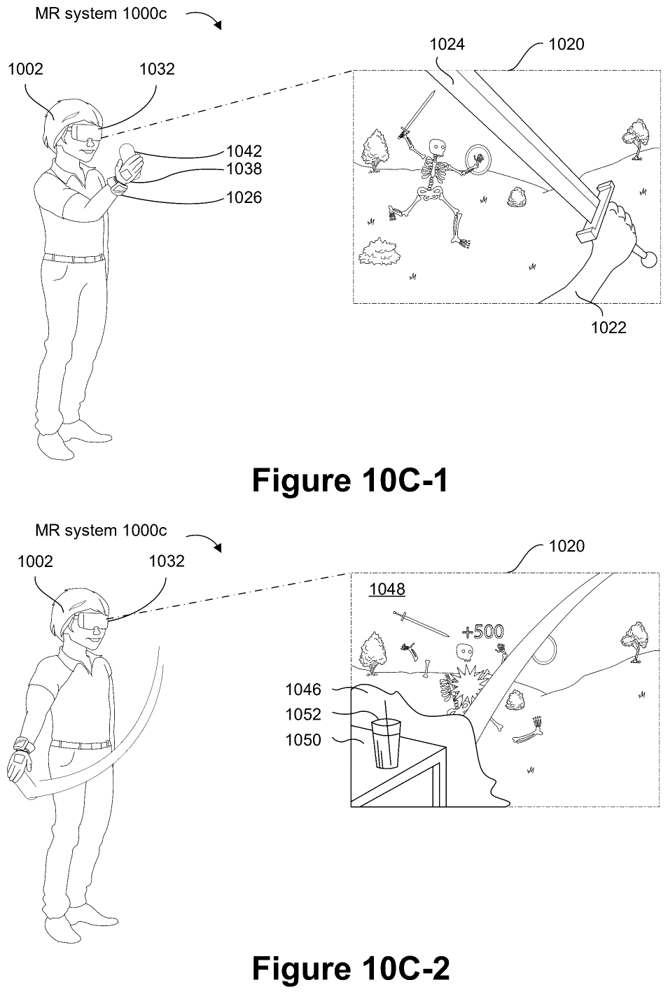

FIG. 1A illustrates a head-worn wearable device 100 (e.g., an extended-reality headset, such as virtual-reality headset or augmented-reality headset shown in FIGS. 10A-10C-2) for use in an extended-reality system placed upon a physical representation of a human head 102 that is configured to record data from one or more sensors, in accordance with some embodiments. As shown in FIG. 1A, the head-worn wearable device is placed upon a physical representation of a human head 102 that is configured to mimic the shape of a human head.

In some embodiments, the physical representation of a human head 102 is a hard plastic structure (e.g., an ABS plastic structure). In some embodiments, the hard plastic structure is configured to mimic physical properties of a human arm.

The physical representation of a human head 102 (e.g., a mannequin head) is configured to provide data from sensors (e.g., mechanical force sensor(s) 104, pressure sensor(s) 106, and/or heat flux sensor(s) 108) located in/on the physical representation of a human head 102 while a head-worn wearable device 100 is placed on the physical representation of a human head 102. The data (e.g., a mechanical-based wearability data, a pressure-based wearability data, and/or a thermal-based wearability data) is used to select an ergonomic feature of the head-worn wearable device 100 based on one or more of: a mechanical-based wearability parameter, a pressure-based wearability parameter, and/or thermal-based wearability parameter. In some embodiments, the ergonomic feature of the head-worn wearable device 100 is a feature that is configured to improve the level of comfort that the user experiences while wearing the wearable device (e.g., less weight, more balanced weight distribution, interference of a wearer's physical feature (e.g., nose bridge, cheek profile, top of head shape, etc.), less heat transfer to the wearer's head, pressure points on the wearer's face, etc.).

The physical representation of a human head 102 shows illustrative predetermined positions of mechanical force sensor 104, pressure sensor 106, and/or heat flux sensor 108. In some embodiments, the predetermined positions are the sections of the mannequin head that correspond to sections where the head-worn wearable device 100 contacts the physical representation of a human head 102 (i.e., locations that would contact a wearer of the head-worn wearable device 102). For example, in FIG. 1A, the predetermined positions are around a physical representation of human eyes 110A-110B of the physical representation of a human head 102 (obscured by head-worn wearable device 100), on a physical representation of a human nose 112 of physical representation of a human head 102, and near a physical representation of human ears 114A-114B of the physical representation of a human head 102 because a head-worn wearable device 100 is configured to surround the wearer's eyes, rest on the wearer's nose, and/or cover the wearer's ears. The locations of the sensors shown in FIG. 1A are for illustrative purposes, but placement of sensors on any portion of the physical representation of a human head 102 is conceived (e.g., placement of sensors in locations that are not in contact with the head-worn device 100 and placement of sensors in locations that are in contact with the head-worn device 100). In some embodiments, placement of sensors can be changed between tests, such that specific locations can be tested as needed (e.g., changes in placement of sensors between revisions of the headset (i.e., a change in shape of the design can cause a pressure change elsewhere)).

FIG. 1A also illustrates a mechanical force chart 116, a pressure chart 118, and a heat transfer chart 120 that each show data received from mechanical force sensor(s) 104, pressure sensor(s) 106, and/or heat flux sensor(s) 108, respectively, as a result of the head-worn wearable device 100 being placed upon the physical representation of a human head 102.

The mechanical force chart 116 shows the amount of mechanical force transmitted from the head-worn wearable device 100 to the physical representation of a human head 102 over a period of time. In some embodiments, mechanical force can refer to unwanted vibrations/movements caused by one or more electrical components, mechanical components, and/or electro-mechanical components. In some embodiments, the mechanical force is recorded by using an inertial measurement unit (IMU). The mechanical force chart 116 also shows a dashed line 122 that indicates a predetermined maximum amount of mechanical force that is acceptable to transmit to the physical representation of a human head 102. The mechanical force chart 116 also shows a line 124 indicating a recorded mechanical force, and the chart 116 also shows that the line 124 exceeds, at points, the dashed line 122. Thus, the mechanical force chart 116 illustrates that the recorded mechanical force transmitted from the head-worn wearable device 100 to physical representation of a human head 102 exceeds the predetermined maximum amount of mechanical force. In some embodiments, the threshold is determined by actual wearers who can indicate how much mechanical force is deemed to be comfortable (e.g., non-intrusive vibration).

The pressure chart 118 shows the amount of pressure transmitted from the head-worn wearable device 100 to the physical representation of a human head 102 over a period of time. In some embodiments, pressure can refer to the pressure applied to the physical representation of a human head 102 by the weight of the head-worn wearable device 100. In some embodiments, the pressure is recorded by using a flexible (e.g., conformable to a non-flat shape) capacitive sensor or an array of flexible capacitive sensors. In some embodiments, the flexible capacitive sensor is embedded within a synthetic dermis layer (e.g., a 1.5 millimeters (mm) Shore 10A synthetic biocompatible skin layer) on the surface of the physical representation of a human head 102. The pressure chart 118 also shows a dashed line 126 that indicates a predetermined maximum amount of pressure that is acceptable to transmit to the physical representation of a human head 102. The pressure chart 118 also shows a line 128 indicating a recorded pressure, and the chart 118 also shows that line 128 exceeds, at points, the dashed line 126. Thus, the pressure chart 118 illustrates that the recorded pressure transmitted from the head-worn wearable device 100 to the physical representation of a human head 102 exceeds the predetermined maximum amount of pressure. In some embodiments, the threshold is determined by actual wearers who can indicate how much pressure is deemed to be comfortable (e.g., not an excessive amount of pressure at a given location (i.e., pressure points) that causes premature doffing of the head-worn device 100 or a non-intrusive weight).

The heat transfer chart 120 shows the amount of heat transmitted from the head-worn wearable device 100 to the physical representation of a human head 102 over a period of time. In some embodiments, heat transfer can refer to the heat transmitted to the physical representation of a human head 102 by the electronic components of the head-worn wearable device 100. In some embodiments, the heat transfer is recorded by heat flux sensors that work in conjunction with thermocouples that are configured to measure temperature. In some embodiments, the heat flux sensors and/or thermocouples are embedded within the synthetic dermis layer. In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables a more accurate heat transfer measurement (e.g., accurately representing the conditions a wearer would experience). The heat transfer chart 120 also shows a dashed line 130 that indicates a predetermined maximum amount of heat that is acceptable to transmit to the physical representation of a human head 102. The heat transfer chart 120 also shows a line 132 indicating a recorded heat transfer, and the chart 120 illustrates that the recorded heat transmitted from the head-worn wearable device 100 to the physical representation of a human head 102 exceeds the predetermined maximum amount of heat transfer. In some embodiments, the threshold is determined by actual wearers who can indicate how much heat transfer is deemed to be comfortable (e.g., non-intrusive amount of heat emitted from the head-worn wearable device). While not shown in this figure, a separate chart indicating just temperature, as opposed to heat, is also possible, where the temperature data is received from a thermocouple. This separate temperature chart can also have a maximum temperature that should not be exceeded so as to avoid discomfort, pain, and/or injury.

FIG. 1B illustrates an adjusted head-worn wearable device 134 with an adjusted design placed upon the physical representation of a human head 102 based on sensor data retrieved from one or more sensors of the physical representation of a human head 102, in accordance with some embodiments. The adjusted head-worn wearable device 134 in FIG. 1B is different from the head-worn wearable device 100 shown in FIG. 1A as an ergonomic feature (e.g., one or more of shape, weight distribution, heat transfer components, weight, material selection, operation of electrical components, etc.) of the adjusted head-worn wearable device 134 has been configured based on the mechanical-based wearability data, pressure-based wearability data, and/or thermal-based wearability data described in reference to FIG. 1A. In particular, the ergonomic features have been selected to improve the level of comfort that the user experiences while wearing the adjusted head-worn wearable device 134 (e.g., quieter operation, cooler operation, reduction in contact pressure points, lighter weight, etc.).

FIG. 1B also illustrates another mechanical force chart 136, another pressure chart 138, and another heat transfer chart 140 that each show data received from mechanical force sensor(s) 104, pressure sensor(s) 106, and/or heat flux sensor(s) 108, respectively, as a result of the adjusted head-worn wearable device 134 being placed upon the physical representation of a human head 102.

The other mechanical force chart 136 shows the amount of mechanical force transmitted from the adjusted head-worn wearable device 134 to the physical representation of a human head 102 over another period of time, as compared to the period of time described in reference to FIG. 1A. The other mechanical force chart 136 also shows the dashed line 122 (same as the dashed line 122 in FIG. 1A) no longer being exceeded as represented by line 142 indicating another recorded mechanical force. Thus, the other mechanical force chart 136 illustrates that the recorded mechanical force transmitted from the adjusted head-worn wearable device 134 to physical representation of a human head 102 does not exceed the predetermined maximum amount of mechanical force. Because the recorded mechanical force does not exceed the predetermined maximum amount of mechanical force, the user of the adjusted head-worn wearable device 134 will only experience a comfortable amount of mechanical force (e.g., non-intrusive vibration). In other words, the recorded mechanical force data discussed in reference to FIG. 1A was used to allow for adjusted head-worn wearable device 134 to be designed in a way that allowed a predetermined maximum amount of mechanical force to not be reached or exceeded.

The other pressure chart 138 shows the amount of pressure transmitted from the adjusted head-worn wearable device 134 to the physical representation of a human head 102 over another period of time, as compared to the period of time described in reference to FIG. 1A. The other pressure chart 138 also shows the dashed line 126 (same as the dashed line 126 in FIG. 1A) no longer being exceeded as represented by line 144 indicating another recorded pressure. Thus, the other pressure chart 138 illustrates that the recorded pressure transmitted from the adjusted head-worn wearable device 134 to physical representation of a human head 102 does not exceed the predetermined maximum amount of pressure. Because the recorded pressure does not exceed the predetermined maximum amount of pressure, the user of the adjusted head-worn wearable device 134 will only experience a comfortable amount of pressure (e.g., non-intrusive weight). In other words, the recorded pressure data discussed in reference to FIG. 1A was used to allow for adjusted head-worn wearable device 134 to be designed in a way that allowed a predetermined maximum amount of pressure to not be reached or exceeded.

The other heat transfer chart 140 shows the amount of heat transmitted from the adjusted head-worn wearable device 134 to the physical representation of a human head 102 over another period of time, as compared to the period of time described in reference to FIG. 1A. The other heat transfer chart 140 also shows the dashed line 130 (same as the dashed line 130 in FIG. 1A) no longer being exceeded as represented by line 146 indicating another recorded heat transfer. Thus, the other heat transfer chart 140 illustrates that the recorded heat transmitted from the adjusted head-worn wearable device 134 to the physical representation of a human head 102 does not exceed the predetermined maximum amount of heat transfer. Because the recorded pressure does not exceed the predetermined maximum amount of heat transfer, the user of the adjusted head-worn wearable device 134 will only experience a comfortable amount of heat transfer (e.g., non-intrusive amount of heat emitted from the head-worn wearable device). In other words, the recorded heat transfer data discussed in reference to FIG. 1A was used to allow for adjusted head-worn wearable device 134 to be designed in a way that allowed a predetermined maximum amount of heat transfer and/or temperature to not be reached or exceeded.

FIG. 2A illustrates an arm-worn wearable device 150 (e.g., a smart band including biopotential sensors and/or computing components, or an extended-reality wrist-wearable (i.e., virtual-reality wrist-wearable or augmented-reality wrist-wearable) as shown in FIGS. 10A-10C-2) for use in an extended-reality system placed upon a physical representation of a human arm 152 that is configured to record data from one or more sensors, in accordance with some embodiments. As shown in FIG. 2A, the arm-worn wearable device is placed upon a physical representation of a human arm 152 that is configured to mimic the shape of a human arm.

In some embodiments, the physical representation of a human arm 152 is a hard plastic structure (e.g., an ABS plastic structure). In some embodiments, the hard plastic structure is configured to mimic physical properties of a human arm.

The physical representation of a human arm 152 (e.g., a mannequin arm) is configured to provide data from sensors (e.g., mechanical force sensor(s) 154, pressure sensor(s) 156, and/or heat/temperature sensor(s) 158) located in/on the physical representation of a human arm 152 while an arm-worn wearable device 150 is placed on the physical representation of a human arm 152. The data (e.g., a mechanical-based wearability data, a pressure-based wearability data, and/or a thermal-based wearability data) is used to select an ergonomic feature of the arm-worn wearable device 150 based on one or more of: a mechanical-based wearability parameter, a pressure-based wearability parameter, and/or thermal-based wearability parameter. In some embodiments, the ergonomic feature of the arm-worn wearable device 150 is a feature that is configured to improve the level of comfort that the user experiences while wearing the wearable device (e.g., less weight, more balanced weight distribution, interference of a wearer's physical feature (e.g., elbow, wrist bone, etc.), less heat transfer to the wearer's arm, pressure points on the wearer's arm, etc.).

The physical representation of a human arm 152 shows illustrative predetermined positions of mechanical force sensor 154, pressure sensor 156, and/or heat/temperature sensor 158. In some embodiments, the predetermined positions are the sections of the mannequin arm that correspond to sections where the arm-worn wearable device 150 contacts the physical representation of a human arm 152 (i.e., locations that would contact a wearer of the arm-worn wearable device 150). For example, in FIG. 2A, the predetermined positions are around a physical representation of human wrist 160, a physical representation of human forearm 162, and a physical representation of human elbow 164 because the arm-worn wearable device 150 can be configured to rest on or cover the wearer's wrist, forearm, and elbow. The locations of the sensors shown in FIG. 2A are for illustrative purposes, but placement of sensors on any portion of the physical representation of a human arm 152 is conceived (e.g., placement of sensors in locations that are not in contact with the arm-worn device 150 and placement of sensors in locations that are in contact with the arm-worn device 150).

FIG. 2A also illustrates a mechanical force chart 166, a pressure chart 168, and a heat transfer chart 170 that each show data received from mechanical force sensor(s) 154, pressure sensor(s) 156, and/or heat/temperature sensor(s) 158, respectively, as a result of the arm-worn wearable device 150 being placed upon the physical representation of a human arm 152.

The mechanical force chart 166 shows the amount of mechanical force transmitted from the arm-worn wearable device 150 to the physical representation of a human arm 152 over a period of time. In some embodiments, mechanical force can refer to unwanted vibrations/movements caused by one or more electrical components, mechanical components, and/or electro-mechanical components. In some embodiments, the mechanical force is recorded by using an inertial measurement unit (IMU). The mechanical force chart 156 also shows a dashed line 172 that indicates a predetermined maximum amount of mechanical force that is acceptable to transmit to the physical representation of a human arm 152. The mechanical force chart 166 also shows a line 174 indicating a recorded mechanical force, and the chart 166 also shows that the line 174 exceeds, at points, the dashed line 172. Thus, the mechanical force chart 166 illustrates that the recorded mechanical force transmitted from the arm-worn wearable device 150 to physical representation of a human arm 152 exceeds the predetermined maximum amount of mechanical force. In some embodiments, the threshold is determined by actual wearers who can indicate how much mechanical force is deemed to be comfortable (e.g., non-intrusive vibration).

The pressure chart 168 shows the amount of pressure transmitted from the arm-worn wearable device 150 to the physical representation of a human arm 152 over a period of time. In some embodiments, pressure can refer to the pressure applied to the physical representation of a human arm 152 by the weight of the arm-worn wearable device 150. In some embodiments, the pressure is recorded by using a flexible (e.g., conformable to a non-flat shape) capacitive sensor or an array of flexible capacitive sensors. In some embodiments, the flexible capacitive sensor is embedded within the synthetic dermis layer on the surface of the physical representation of a human arm 152. The pressure chart 168 also shows a dashed line 176 that indicates a predetermined maximum amount of pressure that is acceptable to transmit to the physical representation of a human arm 152. The pressure chart 168 also shows a line 178 indicating a recorded pressure, and the chart 168 also shows that line 178 exceeds, at points, the dashed line 176. Thus, the pressure chart 168 illustrates that the recorded pressure transmitted from the arm-worn wearable device 150 to the physical representation of a human arm 152 exceeds the predetermined maximum amount of pressure. In some embodiments, the threshold is determined by actual wearers who can indicate how much pressure is deemed to be comfortable (e.g., not an excessive amount of pressure at a given location (i.e., pressure points) that cause premature doffing of the arm-worn wearable device 150 or a non-intrusive weight).

The heat transfer chart 170 shows the amount of heat transmitted from the arm-worn wearable device 150 to the physical representation of a human arm 152 over a period of time. In some embodiments, heat transfer can refer to the heat transmitted to the physical representation of a human arm 152 by the electronic components of the arm-worn wearable device 150. In some embodiments, the heat transfer is recorded by heat flux sensors that work in conjunction with thermocouples. In some embodiments, the heat flux sensors and/or thermocouples are embedded within the synthetic dermis layer. In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables a more accurate heat transfer measurement (e.g., accurately representing the conditions a wearer would experience). The heat transfer chart 170 also shows a dashed line 180 that indicates a predetermined maximum amount of heat that is acceptable to transmit to the physical representation of a human arm 152. The heat transfer chart 170 also shows a line 182 indicating a recorded heat transfer, and the chart 170 illustrates that the recorded heat transmitted from the arm-worn wearable device 150 to the physical representation of a human arm 152 exceeds the predetermined maximum amount of heat transfer. In some embodiments, the threshold is determined by actual wearers who can indicate how much heat transfer is deemed to be comfortable (e.g., non-intrusive amount of heat emitted from the arm-worn wearable device).

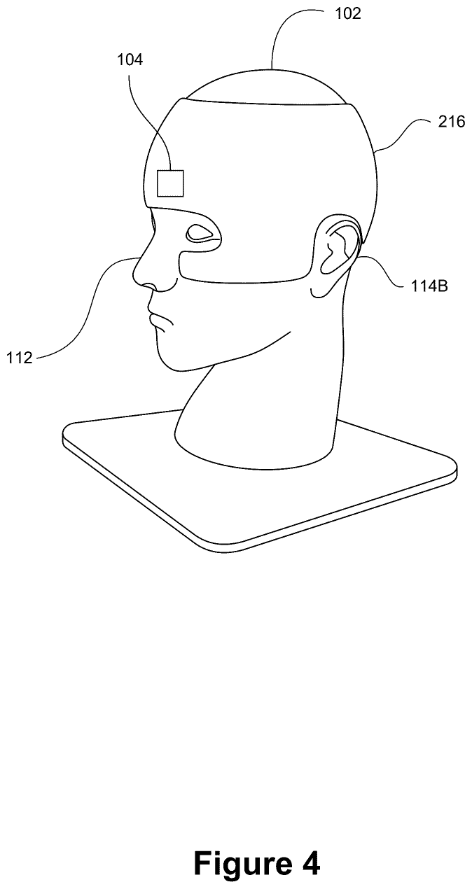

FIG. 2B illustrates an adjusted arm-worn wearable device 184 with an adjusted design placed upon the physical representation of a human arm 152 based on sensor data retrieved from one or more of the sensors of the physical representation of a human arm 152, in accordance with some embodiments. The adjusted arm-worn wearable device 184 in FIG. 4 is different from the arm-worn wearable device 150 in FIG. 2A as an ergonomic feature (e.g., one or more of shape, weight distribution, heat transfer components, weight, material selection, operation of electrical components, etc.) of the adjusted arm-worn wearable device 184 have been configured based on the mechanical-based wearability data, pressure-based wearability data, and/or thermal-based wearability data. In particular, the ergonomic features have been selected to improve the level of comfort that the user experiences while wearing the adjusted arm-worn wearable device 184 (e.g., quieter operation, cooler operation, reduction in contact pressure points, reduced weight, etc.).

FIG. 2B also illustrates another mechanical force chart 186, another pressure chart 188, and another heat transfer chart 190 that each show data received from mechanical force sensor(s) 154, pressure sensor(s) 156, and/or heat/temperature sensor(s) 158, respectively, as a result of the adjusted arm-worn wearable device 184 being placed upon the physical representation of a human arm 152.

The other mechanical force chart 186 shows the amount of mechanical force transmitted from the adjusted arm-worn wearable device 184 to the physical representation of a human arm 152 over another period of time, as compared to the period of time described in reference to FIG. 2A. The other mechanical force chart 186 also shows the dashed line 172 (same as the dashed line 172 in FIG. 2A) no longer being exceeded as represented by the line 192 indicating another recorded mechanical force. Thus, the other mechanical force chart 186 illustrates that the recorded mechanical force transmitted from the adjusted arm-worn wearable device 184 to physical representation of a human arm 152 does not exceed the predetermined maximum amount of mechanical force. Because the recorded mechanical force does not exceed the predetermined maximum amount of mechanical force, the user of the adjusted arm-worn wearable device 184 will only experience a comfortable amount of mechanical force (e.g., non-intrusive vibration). In other words, the recorded mechanical force data discussed in reference to FIG. 2A was used to allow for adjusted arm-worn wearable device 184 to be designed in a way that allowed a predetermined maximum amount of mechanical force to not be reached or exceeded.

The other pressure chart 188 shows the amount of pressure transmitted from the adjusted arm-worn wearable device 184 to the physical representation of a human arm 152 over another period of time, as compared to the period of time described in reference to FIG. 2A. The other pressure chart 188 also shows the dashed line 176 (same as the dashed line 176 in FIG. 2A) no longer being exceeded as represented by line 194 indicating another recorded pressure. Thus, the other pressure chart 188 illustrates that the recorded pressure transmitted from the adjusted arm-worn wearable device 184 to the physical representation of a human arm 152 does not exceed the predetermined maximum amount of pressure. Because the recorded pressure does not exceed the predetermined maximum amount of pressure, the user of the adjusted arm-worn wearable device 184 will only experience a comfortable amount of pressure (e.g., non-intrusive weight). In other words, the recorded pressure data discussed in reference to FIG. 2A was used to allow for adjusted arm-worn wearable device 184 to be designed in a way that allowed a predetermined maximum amount of pressure to not be reached or exceeded.

The other heat transfer chart 190 shows the amount of heat transmitted from the adjusted arm-worn wearable device 184 to the physical representation of a human arm 152 over another period of time, as compared to the period of time described in reference to FIG. 2A. The heat transfer chart 190 also shows the dashed line 180 (same as the dashed line 180 in FIG. 2A) no longer being exceeded as represented by line 196 indicating another recorded heat transfer. Thus, the other heat transfer chart 190 illustrates that the recorded heat transmitted from the adjusted arm-worn wearable device 184 to the physical representation of a human arm 152 does not exceed the predetermined maximum amount of heat transfer. Because the recorded pressure does not exceed the predetermined maximum amount of heat transfer, the user of the adjusted arm-worn wearable device 184 will only experience a comfortable amount of heat transfer (e.g., non-intrusive amount of heat emitted from the head-worn wearable device). In other words, the recorded heat transfer data discussed in reference to FIG. 2A was used to allow for adjusted head-worn wearable device 184 to be designed in a way that allowed a predetermined maximum amount of heat transfer and/or temperature not to be reached or exceeded.

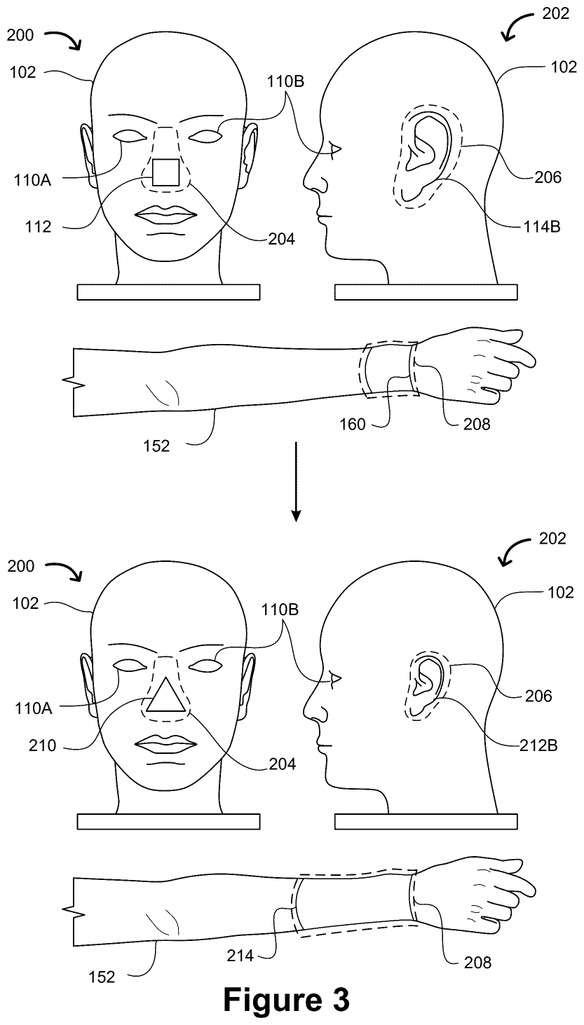

FIG. 3 illustrates the swappable portions of the physical representations of a human head 102 and the physical representation of a human arm 152, in accordance with some embodiments. FIG. 3 shows a front view 200 of the physical representation of a human head 102, a profile view 202 of the physical representation of a human head 102, and a top view of the physical representation of a human arm 152 before and after the swappable portions are swapped. The swappable portions are indicated by dashed lines and can be used to reflect different variations (e.g., different sizes and shapes) of human body parts. Nose portion 204 and ear portion 206 are examples of swappable portions of the physical representation of a human head 102. Wrist portion 208 is an example of a swappable portion of the physical representation of a human arm 152. In some embodiments, the swappable body parts include a plurality of sensors, such as those described in reference to FIGS. 1A-2B.

The physical representation of a human nose 112, which has a square shape, is swapped for a second physical representation of human nose 210, which has a triangular shape. Similarly, the physical representation of a human ear 114B is swapped for a smaller physical representation of a human ear 212B, and the physical representation of a human wrist 160 is swapped for a smaller physical representation of a human wrist 214. Other variations of the swappable portions are also possible (e.g., longer or shorter dorsi on a nose, attached or detached ear lobe on an ear, etc.). The swappable portions (e.g., nose portion 204, ear portion 206, and wrist portion 208) are further configurable across three-degrees of freedom (3-DOF) to further reflect different variations of human body parts. For example, the nose portion 204 can be tilted up or down, and the ear portion 206 can be rotated clockwise or counterclockwise. In some other examples, the nose portion 204 can also translate in and out of the representation of the human face to account for different nose protrusions and/or morphologies. In another embodiments, the ear portion 206 can move in 3-DOF by moving back and forth relative to the front portion of the representation of the face, moving up and down relative to a top portion of the representation of the face, and moving in and out relative to a center point of the representation of the face (e.g., the internal center of a head).

In some embodiments, the nose portion 204, ear portion 206, and/or wrist portion 208 includes one or more magnets (e.g., neodymium magnets) that are coupled to the physical representation of a human head 102 and/or the physical representation of the human arm 152.

In some embodiments, the physical representation of a human head 102 includes a mechanism (e.g., a servo controlled mechanical assembly) for adjusting the interpupillary distance (IPD) between the physical representation of human eyes 110A-110B. In some embodiments, the IPD adjustment is configured to accommodate IPDs within the range of 50 mm to 75 mm.

FIG. 4 illustrates a placement of mechanical force sensors 104 in a region 216 of the physical representation of a human head 102, in accordance with some embodiments. In some embodiments, the surface of the physical representation of a human head 102 is configured to represent a synthetic dermis layer (e.g., a 1.5 mm Shore 10A synthetic biocompatible skin layer). In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables the mechanical force sensors 104 to measure mechanical force transmitted from the head-worn wearable device 100 to the physical representation of a human head 102 more accurately. The mechanical force sensors 104 can be placed under the synthetic dermis layer, embedded within the synthetic dermis layer, and/or placed on top of the synthetic dermis layer. In some embodiments, the mechanical force sensors include accelerometers (e.g., a triaxial accelerometer).

The mechanical force sensors 104 can be placed throughout the region 216. The region 216 can include any sections of the physical representation of a human head 102 where the head-worn wearable device 100 contacts the physical representation of a human head 102. The region 216 can also include the sections on the physical representation of a human head 102 that correspond to the sections on the wearer's head where the wearer of the head-worn wearable device 100 might experience vibrations/movements caused by electrical components, mechanical components, and/or electro-mechanical components of the head-worn wearable device 100 and/or sound emitted from the head-worn wearable device 100. In some embodiments, the region 216 includes the physical representation of human ears 114A-114B and the physical representation of a human nose 112.

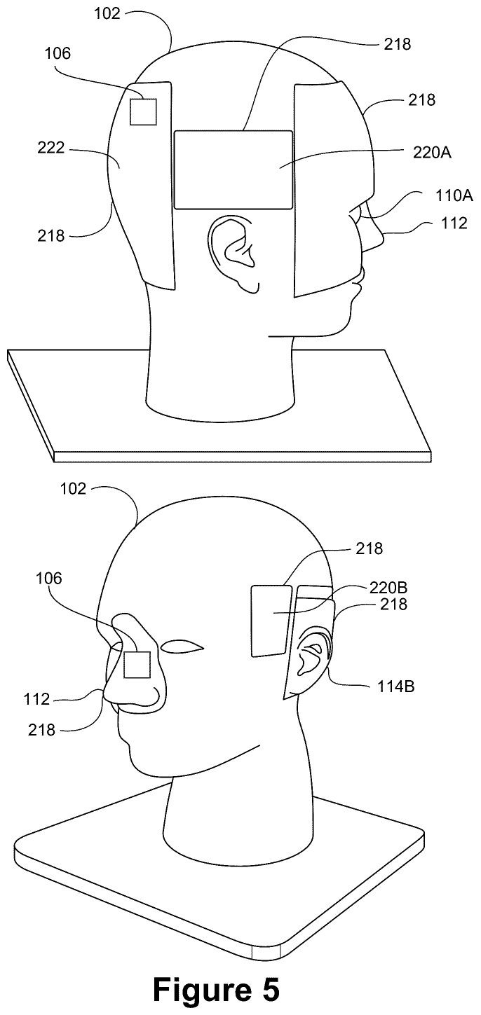

FIG. 5 illustrates two example placements of pressure sensors 106 in a region 218 of the physical representation of a human head 102, in accordance with some embodiments. In some embodiments, the surface of the physical representation of a human head 102 is configured to represent a synthetic dermis layer. In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables the pressure sensors 106 to measure pressure transmitted from the head-worn wearable device 100 to the physical representation of a human head 102 more accurately. The pressure sensors 106 can be placed under the synthetic dermis layer, embedded within the synthetic dermis layer, and/or placed on top of the synthetic dermis layer.

The pressure sensors 106 can be placed throughout the region 218. The region 218 can include any sections of the physical representation of a human head 102 where the head-worn wearable device 100 contacts the physical representation of a human head 102. The region 218 can also include the sections on the physical representation of a human head 102 that correspond to the sections on the wearer's head where the wearer of the head-worn wearable device 100 would experience the weight of the head-worn wearable device 100. For example, in FIG. 5, the region 218 includes the physical representation of a human nose 112, the physical representation of human ears 114A-114B, the physical representation of human temples 220A-220B, and the physical representation of human back/crown of the head 222.

In some embodiments, the pressure sensors 106 include a flexible (e.g., conformable to a non-flat shape) capacitive sensor or an array of flexible capacitive sensors. In some embodiments, the flexible capacitive sensor is embedded within a synthetic dermis layer on the surface of the physical representation of a human head 102. In some embodiments, the array of flexible capacitive sensors has a 1 mm nominal thickness, a linearity of 99.8%, a scan rate of 10 Hertz (Hz) for virtual-reality headsets and a scan rate of 40 Hz for augmented-reality headsets, a full scale range of 0-6 pounds per square inch (psi), and a spatial resolution between 2 mm and 5 mm. In some embodiments, the capacitive sensors are arranged in 16 discrete sensor arrays. In some embodiments, the physical representation of the head contains at least 4,000 capacitive sensors located under the dermis layer to capture the curvature of the head. In some embodiments, the physical representation of the human head contains integrated miniature S-beam load cells located on or in the crown of the physical representation of the head 102 and/or the back of the physical representation of the head 102.

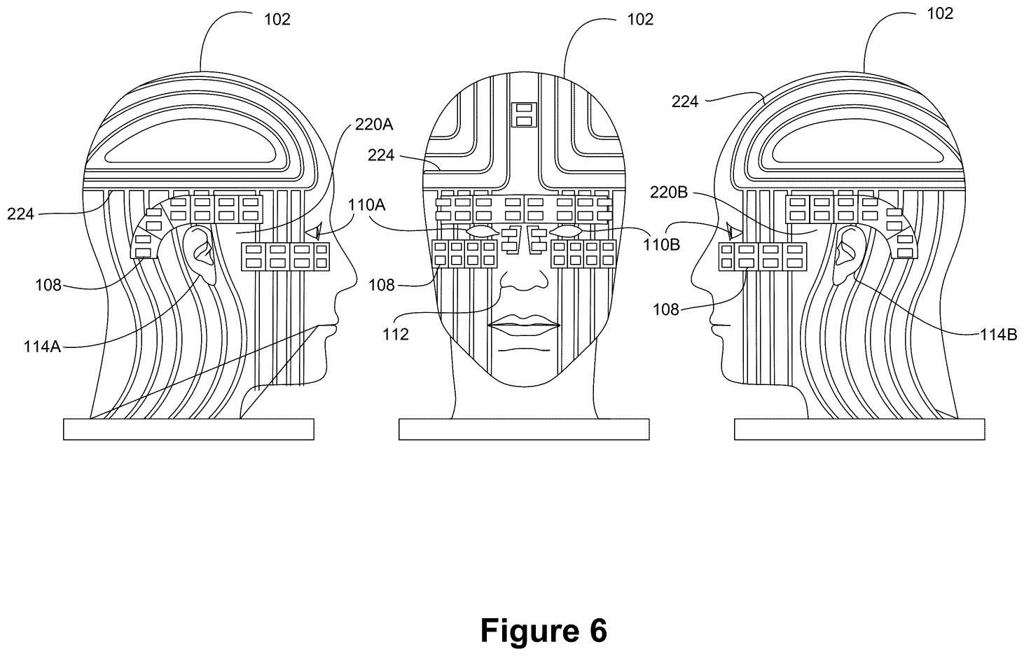

FIG. 6 illustrates a placement of heat flux sensors 108 on and fluid channels 224 within the physical representation of a human head 102, in accordance with some embodiments. FIG. 6 illustrates a left-side view, a front view, and a right-side view of the physical representation of a human head 102. In some embodiments, the surface of the physical representation of a human head 102 is configured to represent a synthetic dermis layer. In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables the mechanical force sensors 104 to measure mechanical force transmitted from the head-worn wearable device 100 to the physical representation of a human head 102 more accurately. The heat flux sensors 108 can be placed under the synthetic dermis layer, embedded within the synthetic dermis layer, and/or placed on top of the synthetic dermis layer.

The heat flux sensors 108 can be placed throughout any sections of the physical representation of a human head 102 where the head-worn wearable device 100 contacts the physical representation of a human head 102. The heat flux sensors 108 can be placed throughout the sections on the physical representation of a human head 102 that correspond to the sections on the wearer's head where the wearer of the head-worn wearable device 100 would experience the heat transmitted from the electrical components of the head-worn wearable device 100. For example, in FIG. 6, the heat flux sensors 108 are placed throughout the area surrounding the physical representation of human eyes 110A-110B, the bridge of the physical representation of a human nose 112, the area surrounding the physical representation of human ears 114A-114B, and the physical representation of human temples 220A-220B. In some embodiments, the heat flux sensors 108 can be placed on or within the physical representation of human ears 114A-114B. In some embodiments, the heat flux sensors 108 can be placed on or within the physical representation of a human nose 112.

In some embodiments, up to 64 heat flux sensors 108 are placed throughout the physical representation of a human head 102.

In some embodiments, the physical representation of a human head 102 includes one or more heaters (e.g., silicone fiberglass resistive heaters that are vulcanized to the interior of the physical representation of a human head 102) to mimic the natural skin temperature of a wearer of the head-worn wearable device 100. In some embodiments, the heaters are configured to provide three-zone thermal control with up to 150 Watts of total power for temperature regulation in ambient conditions such as 0-35 degrees Celsius (° C.).

In some embodiments, the physical representation of a human head 102 includes one or more fluid filled channels 224 that are configured to mimic the cooling effect of blood flow within human skin. In some embodiments, the fluid channels 224 are 3D printed direct metal laser sintering aluminum ALSi10Mg internal fluid channels. In some embodiments, the fluid channels 224 provide bi-directional heating and/or cooling for expanded test conditions (e.g., 0-40° C. & 1 kW/m² Solar).

In some embodiments, the physical representation of the human head 102 includes a proportional-integral-derivative (PID) controller configured to control a temperature of the physical representation of the human head 102. In some embodiments, the PID controller controls the temperature of the physical representation of the human head 102 via thermocouple sensor feedback. In some embodiments, LabView supports the PID controller and the acquisition of thermal data.

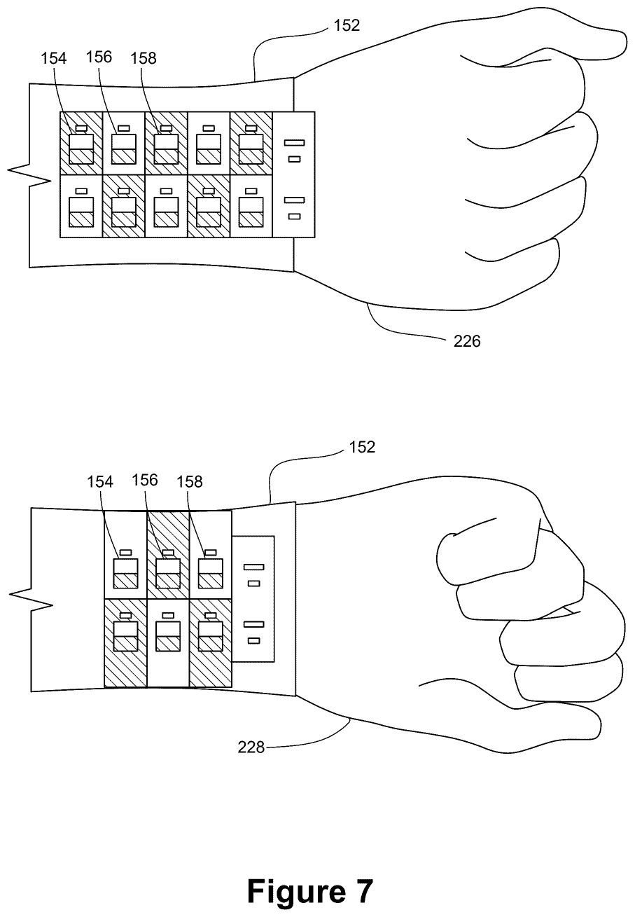

FIG. 7 illustrates a placement of mechanical force sensors 154, pressure sensors 156, and/or heat flux sensors 158 on the physical representation of a human arm 152, in accordance with some embodiments. FIG. 7 illustrates a posterior 226 physical representation of a human arm 152 and an anterior 228 physical representation of a human arm 152. In some embodiments, the surface of the physical representation of a human arm 152 is configured to represent a synthetic dermis layer. In some embodiments, the synthetic dermis layer replicates the resistance, conductivity, emissivity, and thickness of the wearer's skin. In some embodiments, replicating the resistance, conductivity, emissivity, and thickness of the wearer's skin in the synthetic dermis layer enables the mechanical force sensors 154, the pressure sensors 156, and/or the heat flux sensors 158 to measure mechanical force, pressure, and/or heat (respectively) transmitted from the head-worn wearable device 100 to the physical representation of a human arm 152 more accurately. The mechanical force sensors 154, the pressure sensors 156, and/or the heat flux sensors 158 can be placed under the synthetic dermis layer, embedded within the synthetic dermis layer, and/or placed on top of the synthetic dermis layer.

The mechanical force sensors 154, pressure sensors 156, and heat flux sensors 158 can be placed throughout any sections of the physical representation of a human arm 152 where the arm-worn wearable device 150 contacts the physical representation of a human arm 152. In particular, the mechanical force sensors 154 can be placed throughout the sections on the physical representation of a human arm 152 that correspond to the sections on the wearer's arm where the wearer of the arm-worn wearable device 150 might experience vibrations/movements caused by electrical components, mechanical components, and/or electro-mechanical components of the arm-worn wearable device 150 and/or sound emitted from the arm-worn wearable device 150. Similarly, the pressure sensors 156 can be placed throughout the sections on the physical representation of a human arm 152 that correspond to the sections on the wearer's arm where the wearer of the arm-worn wearable device 150 would experience the weight of the arm-worn wearable device 150. Finally, the heat flux sensors 158 can be placed throughout the sections on the physical representation of a human arm 152 that correspond to the sections on the wearer's arm where the wearer of the arm-worn wearable device 150 would experience the heat transmitted from the electrical components of the arm-worn wearable device 150.

In some embodiments, the pressure sensors 156 include a flexible (e.g., conformable to a non-flat shape) capacitive sensor or an array of flexible capacitive sensors. In some embodiments, the flexible capacitive sensor is embedded within a synthetic dermis layer on the surface of the physical representation of a human arm 152. In some embodiments, the array of flexible capacitive sensors has a 1 mm nominal thickness, a linearity of 99.8%, a scan rate of 20 Hz, a full scale range of 0-6 psi, and a spatial resolution between 2 mm and 5 mm.

In some embodiments, up to 32 heat flux sensors 158 are placed throughout the physical representation of a human arm 152.

In some embodiments, the physical representation of the human arm 152 includes a PID controller configured to control a temperature of the physical representation of the human arm 152. In some embodiments, the PID controller controls the temperature of the posterior and anterior sides of the physical representation of the wrist. In some embodiments, the PID controller controls the temperature of the physical representation of the human arm 152 via thermocouple sensor feedback. In some embodiments, LabView supports the PID controller and the acquisition of thermal data. In some embodiments, the PID controller controls the pressure applied to the posterior and anterior sides of the physical representation of the wrist.

In some embodiments, the synthetic silicone is overmolded onto a hard plastic structure (e.g., an ABS structure a PC structure) that is configured to provide shape to the synthetic silicone and mimic physical properties of a human body part. In some embodiments, the synthetic silicone is removable to allow for different thickness synthetic silicones to be used instead (e.g., certain demographics may have different dermis thicknesses).

In some embodiments, the synthetic silicone dermis is configured to have a predefined diffuse Lambertian hemispherical reflectivity that corresponds to an average human dermis reflectivity. In some embodiments, photodiode sensors are placed on or embedded within the synthetic silicone dermis to measure light reflectivity of the synthetic silicone dermis.

In some embodiments, the surface of the physical representation of a human head 102 and/or the physical representation of a human arm 152 is made using a 3D-printed painted nylon to mimic a dermis pigmentation.

In some embodiments, the physical representation of human ears 114A-114B is made of Shore 25A silicone to represent the skin and cartilage of a human ear. In some embodiments, the physical representation of a human nose 112 is made of Shore 25A silicone to represent the cartilage of a human nose.

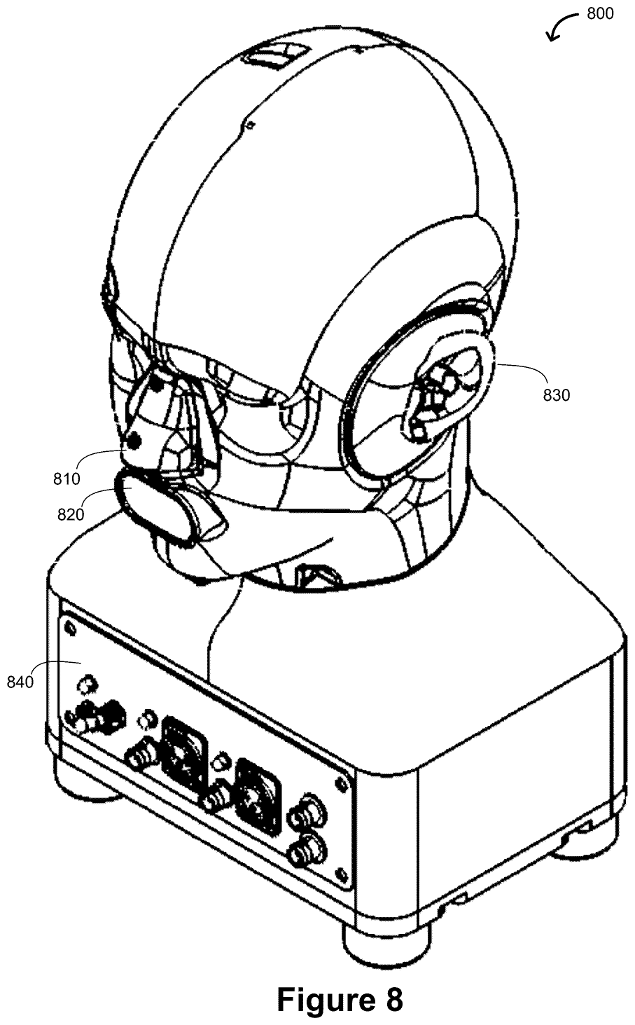

FIG. 8 illustrates another physical representation of a human body part, in accordance with some embodiments. The other physical representation of the human body part 800 can include a first physical representation of a first portion of the human body part 810 (e.g., a physical representation of a human nose) and a second physical representation of a second portion of the human body part 820 (e.g., a physical representation of a human mouth). In some embodiments, the physical representation of the human body part 800 includes one or more third physical representations of third portions of the human body part 830 (e.g., physical representation of human ears). In some embodiments, the other physical representation of the human body part 800 can be configured in accordance with any physical representation of the human head described above in reference to FIGS. 3-6. For example, the first portion of the human body part 810 can include one or more analogous features to those described above in reference to the physical representation of a human nose 112, and the third portions of the human body part 830 can include one or more analogous features to those described above in reference to the physical representation of human ears 114A-114B. In some embodiments, the physical representation of the human body part 800 includes carries over all the core features of the physical representations of the human head described above in reference to FIGS. 3-6.

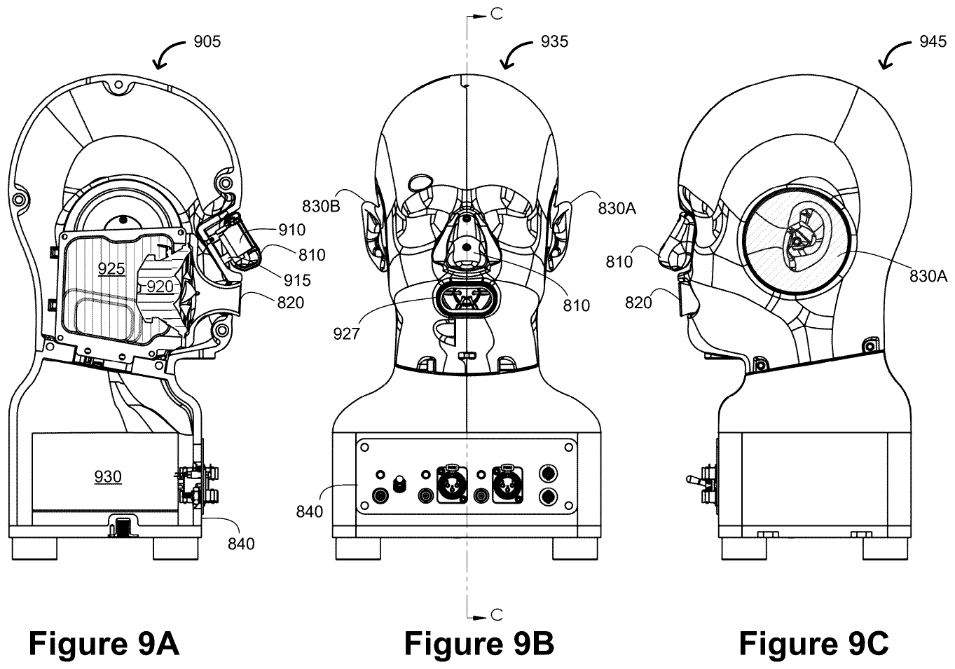

The other physical representation of the human body part 800 can include an interface 840 for providing one or more signals to an actuator 930 (FIG. 9A). As described in detail below, the amplifier 930 can drive one or more actuators such that at least one of the first physical representation of the first portion of the human body part 810 and the second physical representation of the second portion of the human body part 820 are caused to imitate a human reaction. The human reactions can include at least nose vibrations and speech simulation (including mouth simulation).

The other physical representation of the human body part 800 can be based on standardized head sizes. As described below, the other physical representation of the human body part 800 can be designed with multiple physical external-ear height models. The other physical representation of the human body part 800 can be used to test contact mics (cMics). In some embodiments, the other physical representation of the human body part 800 can also be used to test acoustic microphones and speakers on a device under test (e.g., a head-wearable device, such as AR device 1028, MR device 1032, or other devices described below in reference to FIGS. 10A-10C-2). The other physical representation of the human body part 800 allows for testing of user speech without relying on live-user speech captured across a group of individuals. In some embodiments, data collected by the other physical representation of the human body part 800 complements any live-user speech data that is collected. The other physical representation of the human body part 800 can be used for a number of applications including, but not limited to, usage in different levels of testing (system validation, quality assurance, factory automation, etc.), contact mic (cMic) performance testing and validation, and data collection for running key performance indicators.

The first physical representation of the first portion of the human body part 810 may be a representation of a human nose. The first physical representation of the first portion of the human body part 810 interfaces with a portion of a head-wearable device. For example, the first physical representation of the first portion of the human body part 810 may be a representation of a human nose, and a portion of the frames or body of the head-wearable device can interface with (e.g., rest on or couple to) the first physical representation of the first portion of the human body part 810. In some embodiments, a human reaction imitated by the first physical representation of the first portion of the human body part 810 is a nose vibration (e.g., a nose-bridge bone-actuator to mimic vibrations at the nose, so that testing of cMic can be done in the same way as acoustic mics).

In some embodiments, the first physical representation of the first portion of the human body part 810 is one of a plurality of first physical representations of the first portion of the human body part. The first physical representation of the first portion of the human body part 810 can be replaceable with other first physical representations of the plurality of first physical representations of the first portion of the human body part. More specifically, the first physical representation of the first portion of the human body part 810 is swappable with other first physical representation of the first portion of the human body part 810 such that different sizes and/or configurations of a representation of a human nose can be tested and/or used to collect data.

The second physical representation of the second portion of the human body part 820 is a representation of a human mouth. In some embodiments, a human reaction imitated by the second physical representation of the second portion of the human body part 820 is an audible sound. The second physical representation of the second portion of the human body part 820 is configured as a speaker driver and/or mouth simulator.

As described below, in some embodiments, the second physical representation of the second portion of the human body part 820 uses an amplifier 930 that works in unison with an actuator of the first physical representation of the first portion of the human body part 810 (e.g., a nose-bridge bone-actuator) to evaluate speech intelligibility. In some embodiments, the second physical representation of the second portion of the human body part 820 is configured to generate outputs with predetermined frequency responses, predetermined output levels, and predetermined distortion.

In some embodiments, the second physical representation of the second portion of the human body part 820 is one of a plurality of second physical representations of the second portion of the human body part. The second physical representation of the second portion of the human body part 820 can be replaceable with other second physical representations of the plurality of second physical representations of the second portion of the human body part. More specifically, the second physical representation of the second portion of the human body part 820 is swappable with other second physical representation of the second portion of the human body part 820 such that different sizes and/or configurations of a representation of a human mouth can be tested and/or used to collect data.

The third physical representation of the third portion of the human body part 830 may be a representation of human ear. The third physical representation of the third portion of the human body part 830 interfaces with another portion of the head-wearable device. For example, the third physical representation of the third portion of the human body part 830 may be representations of human ears, and temple arms, another frame portion, or another body portion of the head-wearable device can interface with (e.g., rest on or couple to) the third physical representation of the third portion of the human body part 830. The third physical representation of the third portion of the human body part 830 is configured to help characterize the variability of acoustic responses for head-wearable devices.

In some embodiments, the third physical representation of the third portion of the human body part 830 can include different ear shapes selected from a database including one or more ear scans (e.g., high accuracy scans around the ears). In some embodiments, the third physical representation of the third portion of the human body part 830 is one of a plurality of third physical representations of the third portion of the human body part. The third physical representation of the third portion of the human body part 830 can be replaceable with other third physical representations of the plurality of third physical representations of the third portion of the human body part. More specifically, the third physical representation of the third portion of the human body part 830 is swappable with other third physical representation of the third portion of the human body part 830 such that different sizes and/or configurations of representations of human ears can be tested and/or used to collect data. The modular design of the third physical representation of the third portion of the human body part 830 allows for swapping of multiple ear sets into a single form-factor head (e.g., other physical representation of the human body part 800).

In some embodiments, the third physical representation of the third portion of the human body part 830 include replaceable representations of ears around measurement microphones at ear reference points. The third physical representation of the third portion of the human body part 830 can be used to capture data including a noise and/or acoustic leakage due to the nose actuator vibrations (e.g., caused by a first actuator 910 of the first physical representation of the first portion of the human body part 810; FIG. 9A) and cross-talk from a speaker driver (e.g., a second actuator 920 of the second physical representation of the second portion of the human body part 820; FIG. 9A) to internal microphones are other points. The data collected by the third physical representation of the third portion of the human body part 830 can be used for validation (e.g., of a head-wearable device and/or components thereof).

FIGS. 9A-9C illustrate different views of the other physical representation of the human body part, in accordance with some embodiments. FIG. 9A shows a cross-section 905 of the other physical representation of the human body part 800, FIG. 9B shows a front view 935 of the other physical representation of the human body part 800, and FIG. 9C shows a side view 945 of the other physical representation of the human body part 800.

FIG. 9A shows a first physical representation of a first portion of the human body part 810 and a second physical representation of a second portion of the human body part 820, an actuator 930, and an interface 840.

The first physical representation of the first portion of the human body part 810 includes a first actuator 910. In some embodiments, the first actuator 910 is a nose-bridge bone-actuator (or a “nose actuator”) that mimics vibrations at the first physical representation of the first portion of the human body part 810 (e.g., the physical representation of a human nose). In some embodiments, the first actuator 910 is a haptic motor. In some embodiments, the first actuator 910 operates in a first frequency range. In some embodiments, the first frequency range is between 100 Hz-10 kHz, which are frequencies that have been discovered to have the ability to reproduce vibration levels typically measured at the nose (0.001 g to 0.1 g acceleration). In some embodiments, the first frequency range is between at least 200 Hz-7 kHz.

The first actuator 910 is used to simulate vibrations at the nose that are caused due to speech. It has been discovered through experimentation that the best response was available when the first actuator 910 (e.g., a haptics motor) has minimal resistance to motion, and has a rigid connection between the first actuator 910 and the surface (e.g., of the first portion of the human body part 810). To provide the rigid connection between the first actuator 910 and the surface, the first portion of the human body part 810 is isolated or configured as a floating nose that is attached to the rest of the other physical representation of the human body part 800 by two pillars 915. In some embodiments, the isolated or floating configuration of the first portion of the human body part 810 provided the best frequency response that minimized harmonics and provided a good result between the frequencies 100 Hz-7 kHz. The first actuator 910 can be used to test a cMic in the same way an acoustic mic is tested. cMics, unlike audio signals captured with acoustic mics, detect non-linearities likely caused by resonances and clicks within the vocal tract—especially with nasal consonants such as [m] and [n]. The first portion of the human body part 810 and the first actuator 910 allow for testing and validation of cMics to account for the captured data (e.g., at least non-linearities and other data captured during speech).

As described above, the first physical representation of the first portion of the human body part 810 is replaceable with other first physical representations of the plurality of first physical representations of the first portion of the human body part. The modular design of the first physical representation of the first portion of the human body part 810 allows for swapping of multiple first actuators 910 and/or nose sizes for simulation.

The second physical representation of the second portion of the human body part 820 includes a second actuator 920. In some embodiments, the second actuator 920 is a speaker driver. In some embodiments, the second actuator operates in a second frequency range. In some embodiments, the second frequency range is between 80 Hz-16 kHz and can be equalized. The second frequency range has been discovered to have the ability to produce 100 dBspl (e.g., decibels Sound Pressure Level) at a mouth reference point (MRP) (25 mm in front of lip plane). In some embodiments, typical lab tests use 89 dBspl or 95 dBspl speech-active speech level. As described above, the second physical representation of the second portion of the human body part 820 is configured to be equalized between 80 Hz to 16 kHz (to accommodate relevant speech audio frequencies). In some embodiments, the second physical representation of the second portion of the human body part 820 is configured to generate outputs with predetermined output levels, predetermined directivity, and with predetermined distortion.

In some embodiments, the second physical representation of the second portion of the human body part 820 generates continuous output levels at MRP with sine tones. In some embodiments, the second physical representation of the second portion of the human body part 820 generates sine tones with a minimum of 110 dB SPL, 200 Hz to 3 kHz; a minimum of 100 dB SPL, 100 Hz to 11.8 kHz; and/or a minimum of 95 dB SPL, 100 Hz to 12.5 kHz. In some embodiments, the second physical representation of the second portion of the human body part 820 generates continuous output levels at MRP with ⅓-octave Pink Noise. In some embodiments, the second physical representation of the second portion of the human body part 820 generates ⅓-octave Pink Noise with a minimum of 106 dB SPL, 50 Hz to 16 kHz; a minimum of 100 dB SPL, 20 Hz to 20 kHz. In some embodiments, the second physical representation of the second portion of the human body part 820 has a sensitivity at 1 kHz at MRP at 94 dB SPL at 35 mVrms; 110 dB SPL at 0.2 Vrms; and/or 120 dB SPL at 0.7 Vrms. In some embodiments, the second physical representation of the second portion of the human body part 820 has harmonic Distortion at 94 dB SPL that is less than 14% at 100 Hz and/or less than 1% from 300 Hz to 11.8 kHz.

The second physical representation of the second portion of the human body part 820 includes a front plate 927 for the mouth simulator. In some embodiments, the front plate 927 has minimal corners, smooth transitions, and minimal reflective surfaces. In some embodiments, the front plate 927 implements asymmetrical surfaces so as to minimize reflections. In some embodiments, the second physical representation of the second portion of the human body part 820 includes an asymmetrical phase plug in order to smoothen out high frequencies. In some embodiments, the front plate 927 or a simulated mouth of the second physical representation of the second portion of the human body part 820 has an output edge that is flush with a face of the other physical representation of the human body part 800. In some embodiments, the second physical representation of the second portion of the human body part 820 is plugged with foam that helps to further reduce further peaks and valleys in the frequency response.

In some embodiments, the other physical representation of the human body part 800 includes a speaker enclosure 925 including a predetermined back volume. In some embodiments, the predetermined back volume is selected based on simulations. In some embodiments, the predetermined back volume is 0.5 L, 0.3 L, or 0.15 L. In some embodiments, selection of the predetermined back volume is based on constraints of the other physical representation of the human body part 800 (e.g., constraints within a head cavity). In some embodiments, the speaker enclosure 925 is filled with a dampening material (e.g., polyfill) to reduce sound reflections within the speaker enclosure 925.

The amplifier 930 is coupled with the first actuator 910 and the second actuator 920. The amplifier 930 is configured to drive the first physical representation of the first portion of the human body part 810 (e.g., the first actuator 910) and/or the second physical representation of the second portion of the human body part 820 (e.g., the second actuator 920). The amplifier 930 can receive incoming signals for driving the first actuator 910 and the second actuator 920 via the interface 840. The amplifier 930 drives at least one of the first actuator 910 and the second actuator 920 based on the incoming signal, such that at least one of the first physical representation of the first portion of the human body part 810 and/or the second physical representation of the second portion of the human body part 820 are caused to imitate a human reaction (e.g., nose vibrations and/or speech). In some embodiments, the amplifier 930 is a matching 2-channel amplifier that works in unison with the mouth simulator (e.g., the second actuator 920) and nose actuator (e.g., the first actuator 910) and provides necessary amplification for the incoming signals as needed.

In some embodiments, the amplifier 930 is powered by a 15 W power supply that takes in 120-240 V/50-60 Hz supply. In some embodiments, the amplifier 930 provides the second actuator 920 with voltages in the order of 1 to 5V. In some embodiments, the amplifier 930 provides for an amplification of 14 dB. In some embodiments, the amplifier 930 provides the first actuator 910 a maximum rated voltage input of 1.4 Vrms. In some embodiments, in order to maintain the phase between the first actuator 910 and/or the second actuator 920 signals, a second channel the amplifier 930 is enabled with −6 dB gain. In some embodiments, the amplifier 930 implements an adjustable voltage limiter on both channels, so that the maximum permissible levels do not damage the first actuator 910 and/or the second actuator 920.

Turning to FIG. 9B, the front view 935 of the other physical representation of the human body part 800 is shown. The front view 935 of the other physical representation of the human body part 800 shows at least two third physical representations of the third portions of the human body part 830A and 830B. The front view 935 of the other physical representation of the human body part 800 shows also shows the first physical representation of the first portion of the human body part 810 and a front plate 927 of the second physical representation of the second portion of the human body part 820.

FIG. 9C shows the side view 945 of the other physical representation of the human body part 800. The side view 945 of the other physical representation of the human body part 800 shows the first physical representation of the first portion of the human body part 810, the second physical representation of the second portion of the human body part 820, and the third physical representation of the third portion of the human body part 830A. In some embodiments, the third physical representation of the third portion of the human body part 830 is a physical representation of human ears.

The third physical representation of the third portion of the human body part 830 is designed with multiple physical external-ear height models. In some embodiments, each ear model is designed in such a way to help characterize the variability of acoustic responses for head-wearable devices. In some embodiments, ear shapes for the third physical representation of the third portion of the human body part 830 are selected from a database including high accuracy scans around an ear. As described above, the third physical representation of the third portion of the human body part 830 are replaceable with other third physical representations of the plurality of third physical representations of the third portion of the human body part. The modular design of the third physical representation of the third portion of the human body part 830 allows for swapping of multiple ear sets into a single form-factor head.

The third physical representation of a third portion of the human body part 830A includes one or more sensors. The one or more sensors detect interference between the respective imitations of human reactions generated by the first physical representation of the first portion of the human body part 810 (and/or first actuator 910) and/or the second physical representation of the second portion of the human body part 820 (and/or second actuator 920). The third physical representation of the third portion of the human body part 830 interfaces with another portion of the head-wearable device. For example, the third physical representation of the third portion of the human body part 830 can interface with temple arms, frame portions, and/or body portions of a head-wearable device.

(A1) In accordance with some embodiments, A wearable device for use in an extended-reality system that includes an ergonomic feature (e.g., a comfort-based feature) of a wearable device, wherein the ergonomic feature is sized and shaped partially based on data received from one or more sensors that are located at predetermined positions within or on a physical representation of a human body part (e.g., a head of a user, a wrist of a user), the predetermined positions corresponding to a wearability parameter affected by the ergonomic feature (e.g., FIGS. 1-7 illustrate ergonomic features of a wearable device being sized and shaped based on sensors of a physical representation of a human body part). The data received from the one or more sensors is used to determine: (i) a thermal-based wearability parameter indicating an amount heat transferred from the wearable device to the physical representation of the human body part; (ii) a mechanical-based wearability parameter (e.g., motor vibrational data, sound-based vibrational data), indicating an amount of mechanical force transferred from one or more electro-mechanical components located within the wearable device to the physical representation of the human body part; and (iii) a pressure-based wearability parameter indicating an amount of pressure applied by the wearable device to the physical representation of a human body part while affixed. For example, FIGS. 1A-2B and 7 shows one or more sensors is used to determine (i) thermal-based wearability parameter, (ii) a mechanical-based wearability parameter, and (iii) a pressure-based wearability parameter.

(A2) In some embodiments of A1, the wearable device is an extended-reality headset (e.g., a mixed reality headset, an augmented reality headset, and/or a virtual reality headset) and the physical representation of a human body part is a physical representation of a head (e.g., physical representation of a human head 102 shown in FIGS. 1A-1B). In some embodiments, the mixed-reality headset, the augmented reality headset, and the virtual reality headset have different form factors, and in some embodiments sensor locations on the physical representation of the head can be different to accommodate the different form factors.

(A3) In some embodiments of any of A1-A2, the wearable device is a wrist-wearable device (e.g., a smart band including one or more biopotential sensors, and/or one or more computing components, or a smart watch with similar functionality) and the physical representation of the human body part is a physical representation of a wrist of a forearm (e.g., FIGS. 2A-2B show a physical representation of human forearm 162).

(A4) In some embodiments of any of A1-A3, a surface of the physical representation of the human body part that is configured to represent a dermis (e.g., skin) of a user is constructed of synthetic 1.0 mm-2.0 mm silicone (e.g., a shore 10A silicone), wherein the synthetic 1.0 mm-2.0 mm silicone replicates tissue hardness, conductivity, emissivity, and thickness of the human body part. In some embodiments, the thickness of the synthetic silicone is selected based on how thick dermis would be on a human (e.g., a 1.5 mm shore 10A silicone is used to represent the thinner dermis of a face, and a 2.0 mm shore 10A silicone is used to represent the thicker dermis of a wrist). In some embodiments, the synthetic silicone is overmolded onto a hard plastic structure (e.g., an ABS structure a PC structure) that is configured to provide shape to the synthetic silicone and mimic physical properties of a head. In some embodiments, the synthetic silicone is removable to allow for different thickness synthetic silicones to be used instead (e.g., certain demographics may have different dermis thicknesses). For example, FIGS. 1A-1B illustrate a dermis later on the surface of the physical representation of a human head 102, and Figures illustrate a dermis later on the surface of the physical representation of a human forearm 162.

(A5) In some embodiments of A4, the surface is configured to have a predefined diffuse Lambertian hemispherical reflectivity that corresponds to an average human dermis reflectivity, and one or more photodiode sensors are configured to measure light reflectivity of the surface. In some embodiments, the photodiode sensors (e.g., s120c photodiode resisters) are embedded in the surface. In some embodiments, the surface is made using a 3D-printed painted nylon to mimic a dermis pigmentation.

(A6) In some embodiments of A1-A5, the one or more sensors includes an accelerometer (e.g., a triaxial ADI accelerometer) configured to provide, in part, the mechanical-based wearability parameter. For example, FIG. 4 illustrates that the mechanical force sensors include accelerometers.

(A7) In some embodiments of A1-A6, a portion of the physical representation of a human body part is swappable to reflect different variations of human body parts, and the portion is further configurable across three-degrees of freedom (3-DOF) to further reflect the different variations of human body parts. For example, FIG. 3 illustrates the swappable portions of the physical representations of a human head 102 and the physical representation of a human arm 152.

(A8) In some embodiments of A1-A7, the portion is a representation of a human ear that, and the representation of the human ear includes a sensor of the one or more sensors that is used to determine a portion of the pressure-based wearability parameter. In some embodiments, the representation of the human ear is made of shore 25A silicone to represent the cartilage of an ear. In some embodiments, the representation of the human ear includes one or more magnets (e.g., neodymium magnets that are coupled the representation of the human, which can be produced using Proto Eggshell molding methods) allowing the ears to be easily swappable on a larger physical representation of a head. In some embodiments, the representation of the human ear includes three Pressure Microphones, two of which are in a representation of an ear canal and one of which that is inside the head. In some embodiments, the pressure microphones can be adjusted via adjustable mounts. In some embodiments, the representation of the human ear is also configured to include one or more sensors that are used to determine the mechanical-based wearability parameter and/or the thermal-based wearability parameter. For example, FIG. 3 includes a representation of a human ear 114A-114B that includes one or more sensors for determining a mechanical wearability parameter, a pressure wearability parameter, and/or a heat transfer wearability parameter.

(A9) In some embodiments of A1-A8, the portion is a representation of a human nose that includes a sensor of the one of more sensors that is used to determine a portion of the pressure-based wearability parameter. In some embodiments, the representation of the human nose is made of shore 25A silicone to represent the cartilage of a nose. In some embodiments, the representation of the human nose includes one or more magnets (e.g., neodymium magnets that are coupled the representation of the human, which can be produced using advanced 3D printing and casting methodologies allowing the nose to be easily swappable on a larger physical representation of a head. In some embodiments, the representation of the human nose is also configured to include one or more sensors that are used to determine the mechanical-based wearability parameter and/or the thermal-based wearability parameter. For example, FIG. 3 includes a representation of a human nose 204 that includes one or more sensors for determining a mechanical wearability parameter, a pressure wearability parameter, and/or a heat transfer wearability parameter.

(A10) In some embodiments of A1-A9, the portion is a representation of a human wrist that includes a sensor of the one or more sensors that is used to determine a portion of the thermal-based wearability parameter. In some embodiments, the representation of the human wrist includes one or more magnets (e.g., neodymium magnets that are coupled the representation of the human, which can be produced using advanced 3D printing and casting methodologies) allowing the wrist to be easily swappable on a larger physical representation of a forearm. In some embodiments, the physical representation of the human body part includes a proportional-integral-derivative (PID) controller configured to control a temperature of the physical representation of the human body part. In some embodiments, the PID controller controls the temperature of the posterior and anterior sides of the physical representation of the wrist. In some embodiments, the PID controller controls the temperature of the physical representation of the human body part via thermocouple sensor feedback. In some embodiments, the representation of the human wrist is also configured to include one or more sensors that are used to determine the mechanical-based wearability parameter and/or the pressure-based wearability parameter. In some embodiments, the PID controller controls the pressure applied to the posterior and anterior sides of the physical representation of the wrist. For example, FIG. 3 shows that the physical representation of a human wrist 160 is swapped for a smaller physical representation of a human wrist 214.

(A11) In some embodiments of A1-A10, the physical representation of the human body part is a representation of a head and includes a mechanism (e.g., a servo controlled mechanical assembly) for adjusting the interpupillary distance of representation of eyes for the head. In some embodiments, the IPD adjustment is configured to accommodate IPDs within the range of 50 mm to 75 mm. In some embodiments, the representation of the eyes include one or more sensors for determining how much light is transmitted to the representation of the eyes and surrounding area around the representation of the eyes. For example, FIGS. 1-7 illustrate representations of human body parts that include a synthetic silicone dermis that is configured to have a predefined diffuse Lambertian hemispherical reflectivity that corresponds to an average human dermis reflectivity.

(A12) In some embodiments of A1-A11, the physical representation of the human body part includes one or more fluid filled channels that are configured to mimic cooling effect of blood flow within human skin. In some embodiments, the fluid channels are 3D Printed DMLS Aluminum ALSi10Mg internal fluid channels providing bi-directional heating/cooling for expanded test conditions (e.g., 0-40° C. & 1 kW/m² Solar). For example, FIG. 6 illustrates a placement of heat flux sensors on and fluid channels within the physical representation of a human head.

(A13) In some embodiments of A1-A12, one of the one or more sensors is a heat flux sensor and the heat flux sensor is configured to provide data used to determine the thermal-based wearability parameter (e.g., FIGS. 1-7 illustrate that the representations of human body parts can include heat flux sensors). In some embodiments, up to 64 different heat flux sensors are used. In some embodiments, the heat flux sensors are located where the wearable device contacts the mannequin. In some embodiments, the heat flux sensors are located where the sections of the wearable device where the electrical components are concentrated contact the mannequin. In some embodiments, the physical representation of the human body part includes one or more heaters (e.g., silicone fiberglass resistive heaters vulcanized) to mimic natural skin temperature of a wearer of the wearable device. In some embodiments, the one or more heaters are configured to provide three-zone thermal control with up to 150 W of total power for temperature regulation in ambient conditions such as 0-35° C. In some embodiments, one or more of the sensors is a thermocouple that is configured to work in conjunction with the heat flux sensor to increase fidelity of heat measurements.

(A14) In some embodiments of A1-A13, the one or more sensors is a capacitive sensor and the capacitive sensor is configured to provide data that is used to determine the pressure-based wearability (e.g., FIGS. 1-7 illustrate that the representations of human body parts can include pressure sensors). In some embodiments, the capacitive sensor is part of a flexible array that include a plurality of capacitive sensors, wherein the flexible array is configured to conform to a curvature. In some embodiments, the flexible array is constructed, in part, with synthetic (biocompatible) dermis layer (e.g., 1.5 mm Shore 10A silicone). In some embodiments, the sensor array has a 1 mm nominal thickness, a linearity of 99.8%, scan rate of 10 Hz (corresponding to VR headsets) and a scan rate of 40 Hz (corresponding to AR headsets), a full scale range (FSR) of 0-6 psi (42 kPa), and a spatial resolution between 2-5 mm². In some embodiments, the capacitive sensors are located on or in the ears, the nose, the face, the temples, the crown, and the back of the physical representation of the head. In some embodiments, the capacitive sensors are arranged in 16 discrete sensor arrays. In some embodiments, the physical representation of the head contains at least 4,000 capacitive sensors located under the dermis layer to capture the curvature of the head. In some embodiments, the physical representation of the human head contains integrated miniature S-beam load cells located on or in the crown of the physical representation of the head and/or the back of the physical representation of the head.

(B1) In accordance with some embodiments, a physical representation of a human body part used for measuring an ergonomic feature of a wearable device of an extended-reality system, the physical representation of a human body part comprises one or more sensors coupled with the physical representation of the human body part, wherein the physical representation of a human body part (e.g., a head of a user, a wrist of a user) is configured to interface with a wearable device. The one or more sensors are configured to provide data that is used to determine an ergonomic feature of the wearable device, where the data is used to determine: (i) a thermal-based wearability parameter indicating an amount of heat transferred from the wearable device to the physical representation of a human body part; (ii) a mechanical-based wearability parameter (e.g., motor vibrational data, sound-based data, etc.), indicating an amount of mechanical force transferred from one or more electro-mechanical components located within the wearable device to the physical representation of a human body part; and (iii) a pressure-based wearability parameter indicating an amount of pressure applied by the wearable device to the physical representation of a human body part while affixed.

(B2) In some embodiments of B1, the physical representation of a human body part is configured in accordance with any of A1-14.

(C1) In accordance with some embodiments, a physical representation of a human body part is provided. The physical representation of a human body part includes a first physical representation of a first portion of the human body part including a first actuator, a second physical representation of a second portion of the human body part including a second actuator, and an amplifier coupled with the first actuator and the second actuator. The first physical representation of the first portion of the human body part interfaces with a portion of a head-wearable device. The amplifier, in response to receiving an incoming signal via an interface, drives at least one of the first actuator and the second actuator based on the incoming signal, such that at least one of the first physical representation of the first portion of the human body part and the second physical representation of the second portion of the human body part are caused to imitate a human reaction.

(C2) In some embodiments of C1, the first physical representation of the first portion of the human body part is a representation of a human nose; and the human reaction imitated by the first physical representation of the first portion of the human body part is a nose vibration.

(C3) In some embodiments of any one of C1-C2, the second physical representation of the second portion of the human body part is a representation of a human mouth; and the human reaction imitated by the second physical representation of the second portion of the human body part is an audible sound.

(C4) In some embodiments of any one of C1-C3, the amplifier drives the first actuator and the second actuator in unison.

(C5) In some embodiments of any one of C1-C4, the first physical representation of the first portion of the human body part is one of a plurality of first physical representations of the first portion of the human body part; and the first physical representation of the first portion of the human body part is replaceable with each of the first physical representations of the plurality of first physical representations of the first portion of the human body part.

(C6) In some embodiments of any one of C1-C5, the second physical representation of the second portion of the human body part is one of a plurality of second physical representations of the second portion of the human body part; and the second physical representation of the second portion of the human body part is replaceable with each of the second physical representations of the plurality of second physical representations of the second portion of the human body part.

(C7) In some embodiments of any one of C1-C6, the physical representation of the human body part further includes a third physical representation of a third portion of the human body part including a sensor, wherein the third physical representation of the third portion of the human body part interfaces with another portion of the head-wearable device. The sensor detects interference between the respective imitations of human reactions generated by the first physical representation of the first portion of the human body part and the second physical representation of the second portion of the human body part.

(C8) In some embodiments of C7, the third physical representation of the third portion of the human body part is one of a plurality of third physical representations of the third portion of the human body part; and the third physical representation of the third portion of the human body part is replaceable with each of the third physical representations of the plurality of third physical representations of the third portion of the human body part.

(C9) In some embodiments of any one of C1-C8, the first actuator is a haptic motor and the second actuator is a speaker driver.

(C10) In some embodiments of any one of C1-C9, the first actuator operates in a first frequency range, and the second actuator operates in a second frequency range.

(C11) In some embodiments of any one of C1-C10, the physical representation of a human body part is configured in accordance with any of A1-B1.

(D1) In accordance with some embodiments, a non-transitory computer readable storage medium including instructions that, when executed by a computing device, cause the computer device to perform operations corresponding to any of A1-C11.

(E1) In accordance with some embodiments, a method of operating a computing device or electronic device, including operations that correspond to any of A1-C11.

(F1) In accordance with some embodiments, a means for performing the operations that correspond to any of A1-C11.

(G1) In accordance with some embodiments, a system that includes one or more of a wearable devices and a physical representation of the human body part, and the system is configured to perform operations corresponding to any of A1-C11.

(H1) In accordance with some embodiments, a wearable device (e.g., a head-wearable device, wrist-wearable device, etc.) that is configured to perform operations corresponding to any of A1-C11.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

### Example Extended-Reality Systems

FIGS. 10A, 10B, 10C-1, and 10C-2, illustrate example XR systems that include AR and MR systems, in accordance with some embodiments. FIG. 10A shows a first XR system 1000a and first example user interactions using a wrist-wearable device 1026, a head-wearable device (e.g., AR device 1028), and/or a HIPD 1042. FIG. 10B shows a second XR system 1000b and second example user interactions using a wrist-wearable device 1026, AR device 1028, and/or an HIPD 1042. FIGS. 10C-1 and 10C-2 show a third MR system 1000c and third example user interactions using a wrist-wearable device 1026, a head-wearable device (e.g., an MR device such as a VR device), and/or an HIPD 1042. As the skilled artisan will appreciate upon reading the descriptions provided herein, the above-example AR and MR systems (described in detail below) can perform various functions and/or operations.

The wrist-wearable device 1026, the head-wearable devices, and/or the HIPD 1042 can communicatively couple via a network 1025 (e.g., cellular, near field, Wi-Fi, personal area network, wireless LAN). Additionally, the wrist-wearable device 1026, the head-wearable device, and/or the HIPD 1042 can also communicatively couple with one or more servers 1030, computers 1040 (e.g., laptops, computers), mobile devices 1050 (e.g., smartphones, tablets), and/or other electronic devices via the network 1025 (e.g., cellular, near field, Wi-Fi, personal area network, wireless LAN). Similarly, a smart textile-based garment, when used, can also communicatively couple with the wrist-wearable device 1026, the head-wearable device(s), the HIPD 1042, the one or more servers 1030, the computers 1040, the mobile devices 1050, and/or other electronic devices via the network 1025 to provide inputs.

Turning to FIG. 10A, a user 1002 is shown wearing the wrist-wearable device 1026 and the AR device 1028 and having the HIPD 1042 on their desk. The wrist-wearable device 1026, the AR device 1028, and the HIPD 1042 facilitate user interaction with an AR environment. In particular, as shown by the first AR system 1000a, the wrist-wearable device 1026, the AR device 1028, and/or the HIPD 1042 cause presentation of one or more avatars 1004, digital representations of contacts 1006, and virtual objects 1008. As discussed below, the user 1002 can interact with the one or more avatars 1004, digital representations of the contacts 1006, and virtual objects 1008 via the wrist-wearable device 1026, the AR device 1028, and/or the HIPD 1042. In addition, the user 1002 is also able to directly view physical objects in the environment, such as a physical table 1029, through transparent lens(es) and waveguide(s) of the AR device 1028. Alternatively, an MR device could be used in place of the AR device 1028 and a similar user experience can take place, but the user would not be directly viewing physical objects in the environment, such as table 1029, and would instead be presented with a virtual reconstruction of the table 1029 produced from one or more sensors of the MR device (e.g., an outward facing camera capable of recording the surrounding environment).

The user 1002 can use any of the wrist-wearable device 1026, the AR device 1028 (e.g., through physical inputs at the AR device and/or built-in motion tracking of a user's extremities), a smart-textile garment, externally mounted extremity tracking device, the HIPD 1042 to provide user inputs, etc. For example, the user 1002 can perform one or more hand gestures that are detected by the wrist-wearable device 1026 (e.g., using one or more EMG sensors and/or IMUs built into the wrist-wearable device) and/or AR device 1028 (e.g., using one or more image sensors or cameras) to provide a user input. Alternatively, or additionally, the user 1002 can provide a user input via one or more touch surfaces of the wrist-wearable device 1026, the AR device 1028, and/or the HIPD 1042, and/or voice commands captured by a microphone of the wrist-wearable device 1026, the AR device 1028, and/or the HIPD 1042. The wrist-wearable device 1026, the AR device 1028, and/or the HIPD 1042 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1028 (e.g., via an input at a temple arm of the AR device 1028). In some embodiments, the user 1002 can provide a user input via one or more facial gestures and/or facial expressions. For example, cameras of the wrist-wearable device 1026, the AR device 1028, and/or the HIPD 1042 can track the user 1002's eyes for navigating a user interface.

The wrist-wearable device 1026, the AR device 1028, and/or the HIPD 1042 can operate alone or in conjunction to allow the user 1002 to interact with the AR environment. In some embodiments, the HIPD 1042 is configured to operate as a central hub or control center for the wrist-wearable device 1026, the AR device 1028, and/or another communicatively coupled device. For example, the user 1002 can provide an input to interact with the AR environment at any of the wrist-wearable device 1026, the AR device 1028, and/or the HIPD 1042, and the HIPD 1042 can identify one or more back-end and front-end tasks to cause the performance of the requested interaction and distribute instructions to cause the performance of the one or more back-end and front-end tasks at the wrist-wearable device 1026, the AR device 1028, and/or the HIPD 1042. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1042 can perform the back-end tasks and provide the wrist-wearable device 1026 and/or the AR device 1028 operational data corresponding to the performed back-end tasks such that the wrist-wearable device 1026 and/or the AR device 1028 can perform the front-end tasks. In this way, the HIPD 1042, which has more computational resources and greater thermal headroom than the wrist-wearable device 1026 and/or the AR device 1028, performs computationally intensive tasks and reduces the computer resource utilization and/or power usage of the wrist-wearable device 1026 and/or the AR device 1028.

In the example shown by the first AR system 1000a, the HIPD 1042 identifies one or more back-end tasks and front-end tasks associated with a user request to initiate an AR video call with one or more other users (represented by the avatar 1004 and the digital representation of the contact 1006) and distributes instructions to cause the performance of the one or more back-end tasks and front-end tasks. In particular, the HIPD 1042 performs back-end tasks for processing and/or rendering image data (and other data) associated with the AR video call and provides operational data associated with the performed back-end tasks to the AR device 1028 such that the AR device 1028 performs front-end tasks for presenting the AR video call (e.g., presenting the avatar 1004 and the digital representation of the contact 1006).

In some embodiments, the HIPD 1042 can operate as a focal or anchor point for causing the presentation of information. This allows the user 1002 to be generally aware of where information is presented. For example, as shown in the first AR system 1000a, the avatar 1004 and the digital representation of the contact 1006 are presented above the HIPD 1042. In particular, the HIPD 1042 and the AR device 1028 operate in conjunction to determine a location for presenting the avatar 1004 and the digital representation of the contact 1006. In some embodiments, information can be presented within a predetermined distance from the HIPD 1042 (e.g., within five meters). For example, as shown in the first AR system 1000a, virtual object 1008 is presented on the desk some distance from the HIPD 1042. Similar to the above example, the HIPD 1042 and the AR device 1028 can operate in conjunction to determine a location for presenting the virtual object 1008. Alternatively, in some embodiments, presentation of information is not bound by the HIPD 1042. More specifically, the avatar 1004, the digital representation of the contact 1006, and the virtual object 1008 do not have to be presented within a predetermined distance of the HIPD 1042. While an AR device 1028 is described working with an HIPD, an MR headset can be interacted with in the same way as the AR device 1028.

User inputs provided at the wrist-wearable device 1026, the AR device 1028, and/or the HIPD 1042 are coordinated such that the user can use any device to initiate, continue, and/or complete an operation. For example, the user 1002 can provide a user input to the AR device 1028 to cause the AR device 1028 to present the virtual object 1008 and, while the virtual object 1008 is presented by the AR device 1028, the user 1002 can provide one or more hand gestures via the wrist-wearable device 1026 to interact and/or manipulate the virtual object 1008. While an AR device 1028 is described working with a wrist-wearable device 1026, an MR headset can be interacted with in the same way as the AR device 1028.

### Integration of Artificial Intelligence With XR Systems

FIG. 10A illustrates an interaction in which an artificially intelligent virtual assistant can assist in requests made by a user 1002. The AI virtual assistant can be used to complete open-ended requests made through natural language inputs by a user 1002. For example, in FIG. 10A the user 1002 makes an audible request 1044 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 10A also illustrates an example neural network 1052 used in Artificial Intelligence applications. Uses of Artificial Intelligence (AI) are varied and encompass many different aspects of the devices and systems described herein. AI capabilities cover a diverse range of applications and deepen interactions between the user 1002 and user devices (e.g., the AR device 1028, an MR device 1032, the HIPD 1042, the wrist-wearable device 1026). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1002 can interact with an AI model through natural language inputs captured by a voice sensor, text inputs, or any other input modality that accepts natural language and/or a corresponding voice sensor module. In another instance, input is provided by tracking the eye gaze of a user 1002 via a gaze tracker module. Additionally, the AI model can also receive inputs beyond those supplied by a user 1002. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 1028) or from multiple devices that are in communication with each other (e.g., a system that includes at least two of an AR device 1028, an MR device 1032, the HIPD 1042, the wrist-wearable device 1026, etc.). The AI model can also access additional information (e.g., one or more servers 1030, the computers 1040, the mobile devices 1050, and/or other electronic devices) via a network 1025.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1028, an MR device 1032, the HIPD 1042, the wrist-wearable device 1026) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1028, an MR device 1032, the HIPD 1042, the wrist-wearable device 1026), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1042), haptic feedback can provide information to the user 1002. An AI model can also use the inputs described above to determine the appropriate modality and device(s) to present content to the user (e.g., a user walking on a busy road can be presented with an audio output instead of a visual output to avoid distracting the user 1002).

### Example Augmented Reality Interaction

FIG. 10B shows the user 1002 wearing the wrist-wearable device 1026 and the AR device 1028 and holding the HIPD 1042. In the second AR system 1000b, the wrist-wearable device 1026, the AR device 1028, and/or the HIPD 1042 are used to receive and/or provide one or more messages to a contact of the user 1002. In particular, the wrist-wearable device 1026, the AR device 1028, and/or the HIPD 1042 detect and coordinate one or more user inputs to initiate a messaging application and prepare a response to a received message via the messaging application.

In some embodiments, the user 1002 initiates, via a user input, an application on the wrist-wearable device 1026, the AR device 1028, and/or the HIPD 1042 that causes the application to initiate on at least one device. For example, in the second AR system 1000b the user 1002 performs a hand gesture associated with a command for initiating a messaging application (represented by messaging user interface 1012); the wrist-wearable device 1026 detects the hand gesture; and, based on a determination that the user 1002 is wearing the AR device 1028, causes the AR device 1028 to present a messaging user interface 1012 of the messaging application. The AR device 1028 can present the messaging user interface 1012 to the user 1002 via its display (e.g., as shown by user 1002's field of view 1010). In some embodiments, the application is initiated and can be run on the device (e.g., the wrist-wearable device 1026, the AR device 1028, and/or the HIPD 1042) that detects the user input to initiate the application, and the device provides another device operational data to cause the presentation of the messaging application. For example, the wrist-wearable device 1026 can detect the user input to initiate a messaging application, initiate and run the messaging application, and provide operational data to the AR device 1028 and/or the HIPD 1042 to cause presentation of the messaging application. Alternatively, the application can be initiated and run at a device other than the device that detected the user input. For example, the wrist-wearable device 1026 can detect the hand gesture associated with initiating the messaging application and cause the HIPD 1042 to run the messaging application and coordinate the presentation of the messaging application.

Further, the user 1002 can provide a user input provided at the wrist-wearable device 1026, the AR device 1028, and/or the HIPD 1042 to continue and/or complete an operation initiated at another device. For example, after initiating the messaging application via the wrist-wearable device 1026 and while the AR device 1028 presents the messaging user interface 1012, the user 1002 can provide an input at the HIPD 1042 to prepare a response (e.g., shown by the swipe gesture performed on the HIPD 1042). The user 1002's gestures performed on the HIPD 1042 can be provided and/or displayed on another device. For example, the user 1002's swipe gestures performed on the HIPD 1042 are displayed on a virtual keyboard of the messaging user interface 1012 displayed by the AR device 1028.

In some embodiments, the wrist-wearable device 1026, the AR device 1028, the HIPD 1042, and/or other communicatively coupled devices can present one or more notifications to the user 1002. The notification can be an indication of a new message, an incoming call, an application update, a status update, etc. The user 1002 can select the notification via the wrist-wearable device 1026, the AR device 1028, or the HIPD 1042 and cause presentation of an application or operation associated with the notification on at least one device. For example, the user 1002 can receive a notification that a message was received at the wrist-wearable device 1026, the AR device 1028, the HIPD 1042, and/or other communicatively coupled device and provide a user input at the wrist-wearable device 1026, the AR device 1028, and/or the HIPD 1042 to review the notification, and the device detecting the user input can cause an application associated with the notification to be initiated and/or presented at the wrist-wearable device 1026, the AR device 1028, and/or the HIPD 1042.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1028 can present to the user 1002 game application data and the HIPD 1042 can use a controller to provide inputs to the game. Similarly, the user 1002 can use the wrist-wearable device 1026 to initiate a camera of the AR device 1028, and the user can use the wrist-wearable device 1026, the AR device 1028, and/or the HIPD 1042 to manipulate the image capture (e.g., zoom in or out, apply filters) and capture image data.

While an AR device 1028 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 10C-1 and 10C-2, the user 1002 is shown wearing the wrist-wearable device 1026 and an MR device 1032 (e.g., a device capable of providing either an entirely VR experience or an MR experience that displays object(s) from a physical environment at a display of the device) and holding the HIPD 1042. In the third AR system 1000c, the wrist-wearable device 1026, the MR device 1032, and/or the HIPD 1042 are used to interact within an MR environment, such as a VR game or other MR/VR application. While the MR device 1032 presents a representation of a VR game (e.g., first MR game environment 1020) to the user 1002, the wrist-wearable device 1026, the MR device 1032, and/or the HIPD 1042 detect and coordinate one or more user inputs to allow the user 1002 to interact with the VR game.

In some embodiments, the user 1002 can provide a user input via the wrist-wearable device 1026, the MR device 1032, and/or the HIPD 1042 that causes an action in a corresponding MR environment. For example, the user 1002 in the third MR system 1000c (shown in FIG. 10C-1) raises the HIPD 1042 to prepare for a swing in the first MR game environment 1020. The MR device 1032, responsive to the user 1002 raising the HIPD 1042, causes the MR representation of the user 1022 to perform a similar action (e.g., raise a virtual object, such as a virtual sword 1024). In some embodiments, each device uses respective sensor data and/or image data to detect the user input and provide an accurate representation of the user 1002's motion. For example, image sensors (e.g., SLAM cameras or other cameras) of the HIPD 1042 can be used to detect a position of the HIPD 1042 relative to the user 1002's body such that the virtual object can be positioned appropriately within the first MR game environment 1020; sensor data from the wrist-wearable device 1026 can be used to detect a velocity at which the user 1002 raises the HIPD 1042 such that the MR representation of the user 1022 and the virtual sword 1024 are synchronized with the user 1002's movements; and image sensors of the MR device 1032 can be used to represent the user 1002's body, boundary conditions, or real-world objects within the first MR game environment 1020.

In FIG. 10C-2, the user 1002 performs a downward swing while holding the HIPD 1042. The user 1002's downward swing is detected by the wrist-wearable device 1026, the MR device 1032, and/or the HIPD 1042 and a corresponding action is performed in the first MR game environment 1020. In some embodiments, the data captured by each device is used to improve the user's experience within the MR environment. For example, sensor data of the wrist-wearable device 1026 can be used to determine a speed and/or force at which the downward swing is performed and image sensors of the HIPD 1042 and/or the MR device 1032 can be used to determine a location of the swing and how it should be represented in the first MR game environment 1020, which, in turn, can be used as inputs for the MR environment (e.g., game mechanics, which can use detected speed, force, locations, and/or aspects of the user 1002's actions to classify a user's inputs (e.g., user performs a light strike, hard strike, critical strike, glancing strike, miss) or calculate an output (e.g., amount of damage)).

FIG. 10C-2 further illustrates that a portion of the physical environment is reconstructed and displayed at a display of the MR device 1032 while the MR game environment 1020 is being displayed. In this instance, a reconstruction of the physical environment 1046 is displayed in place of a portion of the MR game environment 1020 when object(s) in the physical environment are potentially in the path of the user (e.g., a collision with the user and an object in the physical environment are likely). Thus, this example MR game environment 1020 includes (i) an immersive VR portion 1048 (e.g., an environment that does not have a corollary counterpart in a nearby physical environment) and (ii) a reconstruction of the physical environment 1046 (e.g., table 1050 and cup 1052). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1026, the MR device 1032, and/or the HIPD 1042 are described as detecting user inputs, in some embodiments, user inputs are detected at a single device (with the single device being responsible for distributing signals to the other devices for performing the user input). For example, the HIPD 1042 can operate an application for generating the first MR game environment 1020 and provide the MR device 1032 with corresponding data for causing the presentation of the first MR game environment 1020, as well as detect the user 1002's movements (while holding the HIPD 1042) to cause the performance of corresponding actions within the first MR game environment 1020. Additionally or alternatively, in some embodiments, operational data (e.g., sensor data, image data, application data, device data, and/or other data) of one or more devices is provided to a single device (e.g., the HIPD 1042) to process the operational data and cause respective devices to perform an action associated with processed operational data.

In some embodiments, the user 1002 can wear a wrist-wearable device 1026, wear an MR device 1032, wear smart textile-based garments 1038 (e.g., wearable haptic gloves), and/or hold an HIPD 1042 device. In this embodiment, the wrist-wearable device 1026, the MR device 1032, and/or the smart textile-based garments 1038 are used to interact within an MR environment (e.g., any AR or MR system described above in reference to FIGS. 10A-10B). While the MR device 1032 presents a representation of an MR game (e.g., second MR game environment 1020) to the user 1002, the wrist-wearable device 1026, the MR device 1032, and/or the smart textile-based garments 1038 detect and coordinate one or more user inputs to allow the user 1002 to interact with the MR environment.

In some embodiments, the user 1002 can provide a user input via the wrist-wearable device 1026, an HIPD 1042, the MR device 1032, and/or the smart textile-based garments 1038 that causes an action in a corresponding MR environment. In some embodiments, each device uses respective sensor data and/or image data to detect the user input and provide an accurate representation of the user 1002's motion. While four different input devices are shown (e.g., a wrist-wearable device 1026, an MR device 1032, an HIPD 1042, and a smart textile-based garment 1038) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1038) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1038 can be used in conjunction with an MR device and/or an HIPD 1042.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 10A-10C-2 provided above are intended to augment the description provided in reference to FIGS. 1A-9C. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A physical representation of a human body part, comprising:
a first physical representation of a first portion of the human body part including a first actuator, wherein the first physical representation of the first portion of the human body part interfaces with a portion of a head-wearable device;
a second physical representation of a second portion of the human body part including a second actuator; and
an amplifier coupled with the first actuator and the second actuator, wherein the amplifier, in response to receiving an incoming signal via an interface:
drives at least one of the first actuator and the second actuator based on the incoming signal, such that at least one of the first physical representation of the first portion of the human body part and the second physical representation of the second portion of the human body part are caused to imitate a human reaction.

2. The physical representation of the human body part of claim 1, wherein:
the first physical representation of the first portion of the human body part is a representation of a human nose; and
the human reaction imitated by the first physical representation of the first portion of the human body part is a nose vibration.

3. The physical representation of the human body part of claim 1, wherein:
the second physical representation of the second portion of the human body part is a representation of a human mouth; and
the human reaction imitated by the second physical representation of the second portion of the human body part is an audible sound.

4. The physical representation of the human body part of claim 1, wherein the amplifier drives the first actuator and the second actuator in unison.

5. The physical representation of the human body part of claim 1, wherein:
the first physical representation of the first portion of the human body part is one of a plurality of first physical representations of the first portion of the human body part; and
the first physical representation of the first portion of the human body part is replaceable with each of the first physical representations of the plurality of first physical representations of the first portion of the human body part.

6. The physical representation of the human body part of claim 1, wherein:
the second physical representation of the second portion of the human body part is one of a plurality of second physical representations of the second portion of the human body part; and
the second physical representation of the second portion of the human body part is replaceable with each of the second physical representations of the plurality of second physical representations of the second portion of the human body part.

7. The physical representation of the human body part of claim 1, further comprising:
a third physical representation of a third portion of the human body part including a sensor, wherein the third physical representation of the third portion of the human body part interfaces with another portion of the head-wearable device,
wherein the sensor detects interference between the respective imitations of human reactions generated by the first physical representation of the first portion of the human body part and the second physical representation of the second portion of the human body part.

8. The physical representation of the human body part of claim 7, wherein:
the third physical representation of the third portion of the human body part is one of a plurality of third physical representations of the third portion of the human body part; and
the third physical representation of the third portion of the human body part is replaceable with each of the third physical representations of the plurality of third physical representations of the third portion of the human body part.

9. The physical representation of the human body part of claim 1, wherein:
the first actuator is a haptic motor; and
the second actuator is a speaker driver.

10. The physical representation of the human body part of claim 1, wherein:
the first actuator operates in a first frequency range; and
the second actuator operates in a second frequency range.

11. A non-transitory computer readable storage medium including instructions that, when executed by a physical representation of a human body part, cause the physical representation of the human body part to:
in response to receiving an incoming signal via an interface of an amplifier included in the physical representation of the human body part:
drive, by the actuator, at least one of a first actuator and a second actuator based on the incoming signal, such that at least one of a first physical representation of a first portion of the human body part and a second physical representation of a second portion of the human body part are caused to imitate a human reaction;
wherein:
the first physical representation of the first portion of the human body part includes the first actuator and interfaces with a portion of a head-wearable device,
the second physical representation of the second portion of the human body part includes the second actuator, and
the amplifier is coupled with the first actuator and the second actuator.

12. The non-transitory computer readable storage medium of claim 11, wherein:
the first physical representation of the first portion of the human body part is a representation of a human nose; and
the human reaction imitated by the first physical representation of the first portion of the human body part is a nose vibration.

13. The non-transitory computer readable storage medium of claim 11, wherein:
the second physical representation of the second portion of the human body part is a representation of a human mouth; and
the human reaction imitated by the second physical representation of the second portion of the human body part is an audible sound.

14. The non-transitory computer readable storage medium of claim 11, wherein the amplifier drives the first actuator and the second actuator in unison.

15. The non-transitory computer readable storage medium of claim 11, wherein:
the first physical representation of the first portion of the human body part is one of a plurality of first physical representations of the first portion of the human body part; and
the first physical representation of the first portion of the human body part is replaceable with each of the first physical representations of the plurality of first physical representations of the first portion of the human body part.

16. A method, comprising:
at physical representation of a human body part, comprising:
a first physical representation of a first portion of the human body part including a first actuator, wherein the first physical representation of the first portion of the human body part interfaces with a portion of a head-wearable device,
a second physical representation of a second portion of the human body part including a second actuator, and
an amplifier coupled with the first actuator and the second actuator:
in response to receiving an incoming signal via an interface, driving, by the actuator, at least one of the first actuator and the second actuator based on the incoming signal, such that at least one of the first physical representation of the first portion of the human body part and the second physical representation of the second portion of the human body part are caused to imitate a human reaction.

17. The method of claim 16, wherein:
the first physical representation of the first portion of the human body part is a representation of a human nose; and
the human reaction imitated by the first physical representation of the first portion of the human body part is a nose vibration.

18. The method of claim 16, wherein:
the second physical representation of the second portion of the human body part is a representation of a human mouth; and
the human reaction imitated by the second physical representation of the second portion of the human body part is an audible sound.

19. The method of claim 16, wherein the amplifier drives the first actuator and the second actuator in unison.

20. The method of claim 16, wherein:
the first physical representation of the first portion of the human body part is one of a plurality of first physical representations of the first portion of the human body part; and
the first physical representation of the first portion of the human body part is replaceable with each of the first physical representations of the plurality of first physical representations of the first portion of the human body part.
